(19) United States
(12) Patent Application Publication
(10) Pub. No.: US 2026/0340171 A1
(43) Pub. Date: Oct. 29, 2026

(54) OBJECT CLASS IDENTIFICATION AND ENCRYPTION IN ASSOCIATION WITH CONTEXTUAL DATA

(71) Applicant: QUALCOMM Incorporated, San Diego, CA (US)

(72) Inventor: Khalid TAHBOUB, San Diego, CA (US)

(21) Appl. No.: 19/659,627

(22) Filed: Apr. 27, 2026

Related U.S. Application Data
(60) Provisional application No. 63/796,947, filed on Apr. 29, 2025.

(51) Int. Cl. G06F 21/62; G06F 21/60; G06V 10/25; G06V 10/70; G06V 10/764

(52) U.S. Cl. CPC G06F 21/6218; G06F 21/602; G06V 10/25; G06V 10/764; G06V 10/768

(57) ABSTRACT

A device includes a memory configured to store a content encryption configuration that indicates an object class, an encryption condition, and a status that indicates whether the content encryption configuration is active or inactive. The device also includes one or more processors configured to obtain contextual information associated with input media data and determine whether the encryption condition is satisfied based on the contextual information. The one or more processors are also configured to, based on a determination that the encryption condition is satisfied, change the status of the content encryption configuration to active. The one or more processors are further configured to, based on the encryption condition being satisfied, encrypt a portion of the input media data that includes an instance of the object class to generate encrypted media data.

### I.CROSS-REFERENCE TO RELATED APPLICATIONS

The present application claims priority from the commonly owned U.S. Provisional Patent Application No. 63/796,947, filed Apr. 29, 2025, entitled “OBJECT CLASS IDENTIFICATION AND ENCRYPTION IN ASSOCIATION WITH CONTEXTUAL DATA”, the content of which is incorporated herein by reference in its entirety.

### II.FIELD

The present disclosure is generally related to identification and encryption of media content.

### III.DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

The advances in technology have also made digital cameras ubiquitous to modern life. The prevalence of digital cameras and the availability of low-cost memory devices to store images and videos has resulted in a large amount of image and video content. The ability to generate, store, and share the image and video content has increased privacy and security concerns. For example, privacy concerns may be related to an individual’s right to his or her personal information, likeness or image, or a combination thereof. As another example, privacy concerns have increased in view of the potential of personal content being used to train artificial intelligence (AI) models. Various regulations have been enacted to address such privacy concerns and that detail storage and sharing of images or video collected in certain circumstances, such as images or video collection associated with autonomous driving, a dashboard camera, surveillance systems, in-cabin monitoring or personal use. However, the assumption of privacy varies based on different regulations and in different countries.

One technique that has been used to comply with the various regulations includes masking content to be protected. For example, traditional masking can include encoding an input video into a bitstream and providing manual or automated annotation to the bitstream to generate processed pixel data (e.g., YUV values) that is then encoded into a second bitstream having masked content. Another technique that has been used includes applying an encryption method, such as advanced encryption standard (AES) encryption. For example, an input video is encoded into a bitstream, a fragment/scramble operation is performed on the bitstream to generate bitstream segments, and asymmetric encryption is performed, based on or using a key (e.g., a secret key), on the bitstream segments to generate an encrypted bitstream. However, the conventional techniques can often encrypt more content (e.g., a whole bitstream) than is needed to comply with a regulation, which results in high computational complexity and power consumption. Additionally, the conventional techniques do not allow for both authorized and non-authorized access of encrypted content using the same encrypted bitstream (e.g., a single bitstream having encrypted and/or masked content).

Additionally, some existing approaches to selective data protection operate at a data field or message level, such as systems that parse structured data fields (e.g., database fields, form fields, or message headers) to identify and encrypt sensitive information. Such field-based approaches rely on the structure of the underlying data format to identify content to be protected. In contrast, approaches that operate on media content (e.g., image or video content) may identify content to be protected based on media perception, such as detection and segmentation of objects within the media content, rather than parsing of structured data fields. Accordingly, there is an opportunity for improvement in techniques for selectively protecting media content based on media perception in association with contextual information.

### IV.SUMMARY

According to one implementation of the present disclosure, a device includes a memory configured to store a content encryption configuration that indicates an object class, an encryption condition, and a status that indicates whether the content encryption configuration is active or inactive. The device also includes one or more processors configured to obtain contextual information associated with input media data, and determine whether the encryption condition is satisfied based on the contextual information. The one or more processors are also configured to, based on a determination that the encryption condition is satisfied, change the status of the content encryption configuration to active. The one or more processors are further configured to, based on the encryption condition being satisfied, encrypt a portion of the input media data that includes an instance of the object class to generate encrypted media data.

According to another implementation of the present disclosure, a method includes obtaining a content encryption configuration indicating an object class, an encryption condition, and a status that indicates whether the content encryption configuration is active or inactive. The method also includes obtaining contextual information associated with input media data, and determining whether the encryption condition is satisfied based on the contextual information. The method includes, based on a determination that the encryption condition is satisfied, changing the status of the content encryption configuration to active. The method further includes, based on the encryption condition being satisfied, encrypting a portion of the input media data that includes an instance of the object class to generate encrypted media data.

According to another implementation of the present disclosure, a non-transitory computer-readable medium stores instructions that are executable by one or more processors to cause the one or more processors to obtain a content encryption configuration indicating an object class, an encryption condition, and a status that indicates whether the content encryption configuration is active or inactive. The instructions further cause the one or more processors to obtain contextual information associated with input media data, and determine whether the encryption condition is satisfied based on the contextual information. The instructions also cause the one or more processors to, based on a determination that the encryption condition is satisfied, change the status of the content encryption configuration to active. The instructions further cause the one or more processors to, based on the encryption condition being satisfied, encrypt a portion of the input media data that includes an instance of the object class to generate encrypted media data.

According to another implementation of the present disclosure, an apparatus includes means for obtaining a content encryption configuration indicating an object class, an encryption condition, and a status that indicates whether the content encryption configuration is active or inactive, and means for obtaining contextual information associated with input media data. The apparatus also includes means for determining whether the encryption condition is satisfied based on the contextual information, and means for changing, based on a determination that the encryption condition is satisfied, the status of the content encryption configuration to active. The apparatus further includes means for encrypting, based on the encryption condition being satisfied, a portion of the input media data that includes an instance of the object class to generate encrypted media data.

According to another implementation of the present disclosure, a device includes a memory configured to store a content encryption configuration that indicates an object class and an encryption condition. The device also includes one or more processors configured to obtain contextual information associated with input media data and determine whether the encryption condition is satisfied based on the contextual information. The one or more processors are further configured to detect, in the input media data, an instance of the object class and identify a region of interest corresponding to the instance. The one or more processors are also configured to, based on a determination that the encryption condition is satisfied, encrypt region of interest content corresponding to the region of interest to generate encrypted region of interest data, and mask the region of interest to generate a masked version of the input media data. The one or more processors are further configured to generate output media data comprising a bitstream that includes an encoded masked image frame corresponding to the masked version of the input media data and an encoded encrypted region of interest frame corresponding to the encrypted region of interest data. The encoded encrypted region of interest frame is indicated as a non-display frame by a non-display indicator, and a frame identifier associates the encoded encrypted region of interest frame with the encoded masked image frame.

Other aspects, advantages, and features of the present disclosure will become apparent after review of the entire application, including the following sections: Brief Description of the Drawings, Detailed Description, and the Claims.

### V.BRIEF DESCRIPTION OF THE DRAWINGS

FIG. 1 is a block diagram of an example of a system to identify and encrypt media content, in accordance with one or more aspects of the present disclosure.

FIGS. 2A, 2B, 2C, 2D, and 2E, are diagrams of examples of content encryption configurations associated with the system of FIG. 1, in accordance with one or more aspects of the present disclosure.

FIG. 3 is a diagram of an example of a method for encryption of media content, in accordance with some aspects of the present disclosure.

FIG. 4 is a diagram of an example of a method for encryption of media content, in accordance with some aspects of the present disclosure.

FIGS. 5A, 5B, 5C, 5D, and 5E, are diagrams of examples of image frames to illustrate operations associated with the system of FIG. 1, in accordance with one or more aspects of the present disclosure.

FIG. 6A is a diagram of examples of encoded output data to illustrate operations associated with the system of FIG. 1, in accordance with one or more aspects of the present disclosure.

FIG. 6B is a diagram of an example of a bitstream of encoded output data to illustrate operations associated with the system of FIG. 1, in accordance with one or more aspects of the present disclosure.

FIG. 7A is a diagram of an illustrative example of a processor of the system of FIG. 1, in accordance with one or more aspects of the present disclosure.

FIG. 7B is a diagram of an example of a bitstream of encoded output data to illustrate operations associated with the system of FIG. 7A, in accordance with one or more aspects of the present disclosure.

FIGS. 8A, 8B, 8C, 8D, and 8E, are diagrams of examples of image frames to illustrate operations associated with the system of FIG. 1, in accordance with one or more aspects of the present disclosure.

FIG. 9A is a block diagram of an example of a system to decode media content, in accordance with one or more aspects of the present disclosure.

FIG. 9B is a diagram of an example of operations that may be performed at the system of FIG. 9A.

FIG. 10 is a block diagram of an example of a system to encrypt and decrypt media content, in accordance with one or more aspects of the present disclosure.

FIG. 11 is a diagram of an example of an integrated circuit operable to encrypt or decrypt media content, in accordance with some examples of the present disclosure.

FIG. 12 is a diagram of a mobile device operable to encrypt or decrypt media content, in accordance with some examples of the present disclosure.

FIG. 13 is a diagram of a wearable electronic device operable to encrypt or decrypt media content, in accordance with some examples of the present disclosure.

FIG. 14 is a diagram of a voice-controlled speaker system operable to encrypt or decrypt media content, in accordance with some examples of the present disclosure.

FIG. 15 is a diagram of a camera operable to encrypt or decrypt media content, in accordance with some examples of the present disclosure.

FIG. 16 is a diagram of a headset, such as a virtual reality, mixed reality, or augmented reality headset, operable to encrypt or decrypt media content, in accordance with some examples of the present disclosure.

FIG. 17 is a diagram of a mixed reality or augmented reality glasses device operable to encrypt or decrypt media content, in accordance with some examples of the present disclosure.

FIG. 18 is a diagram of a first example of a vehicle operable to encrypt or decrypt media content, in accordance with some examples of the present disclosure.

FIG. 19 is a diagram of a second example of a vehicle operable to encrypt or decrypt media content, in accordance with some examples of the present disclosure.

FIG. 20 is a diagram of an example of a method of encryption of media content, in accordance with some aspects of the present disclosure.

FIG. 21 is a block diagram of an illustrative example of a device that is operable to encrypt media content, in accordance with one or more aspects of the present disclosure.

### VI.DETAILED DESCRIPTION

The above-described problems associated with encryption of a whole bitstream and/or failure to allow for both authorized and non-authorized access of encrypted content using the same encrypted bitstream are solved by selectively encrypting at least a portion of a bitstream based on a condition (e.g., an encryption condition) of a content encryption configuration being satisfied, as described herein. The present disclosure provides systems, devices, apparatus, methods, and computer-readable media for encryption of media content for media content systems, such as encryption of at least a portion of the media content that includes an object. Some aspects more specifically relate to determining that the condition is satisfied based on contextual data. The condition may indicate to encrypt an object class based on a physical space or an environment, such as a physical space or environment associated with an office, a public space, an outdoor space, a restricted area, or a particular geographic location. Additionally, or alternatively, the condition may indicate to encrypt the object class based on an object, availability of a particular wireless network, a positioning system, or a combination thereof. Based on the condition of the content encryption configuration being satisfied, the content encryption configuration may be determined to have a status of active and an instance of an object class (associated with the condition) may be detected in the media content. A portion of input media data that includes the detected instance of the object class can be encrypted using a key, such as a random key or a public key of a public-private key pair, to generate encrypted media data. Additionally, the portion of the input media can also be masked (e.g., in the input media data) to generate a masked version of the input media data. Output media data, such as a bitstream, is generated that includes the masked version of the input media data, the encrypted media data, or a combination thereof. In some embodiments, the output media data includes an indicator that indicates the output media data is associated with encrypted content, the condition, or a combination thereof.

Particular implementations of the subject matter described in this disclosure can be implemented to realize one or more of the following technical advantages. In some aspects, the present disclosure provides techniques for identifying, based on a condition being satisfied, a region of interest (associated with an object class) of the input media data, and encrypting at least the portion for privacy control and content management. In some examples, the techniques may also mask the sensitive content of the input media data to generate a masked version that can be displayed by one or more device or users that do not have authorization or access to the sensitive content (e.g., the encrypted data). A user or a device that has access to a key can decrypt the encrypted portion and thereby recover the sensitive content and combine the recovered sensitive content with the masked content to generate (e.g., recreate) the original content. In some embodiments, the techniques may be applied to provide automatic sensitive content (partial video) encryption while the video is captured for the first time. The partial video encryption can allow for both authorized and non-authorized access of encrypted content using the same encrypted bitstream, thus reducing the amount of transmission bandwidth and storage capacity that would otherwise be required to accommodate receipt, storage, and playback of both authorized and non-authorized versions of the media data at a device and, as a result, improving the efficiency of the device by enabling provision of both authorized and non-authorized versions using fewer resources as compared to conventional devices.

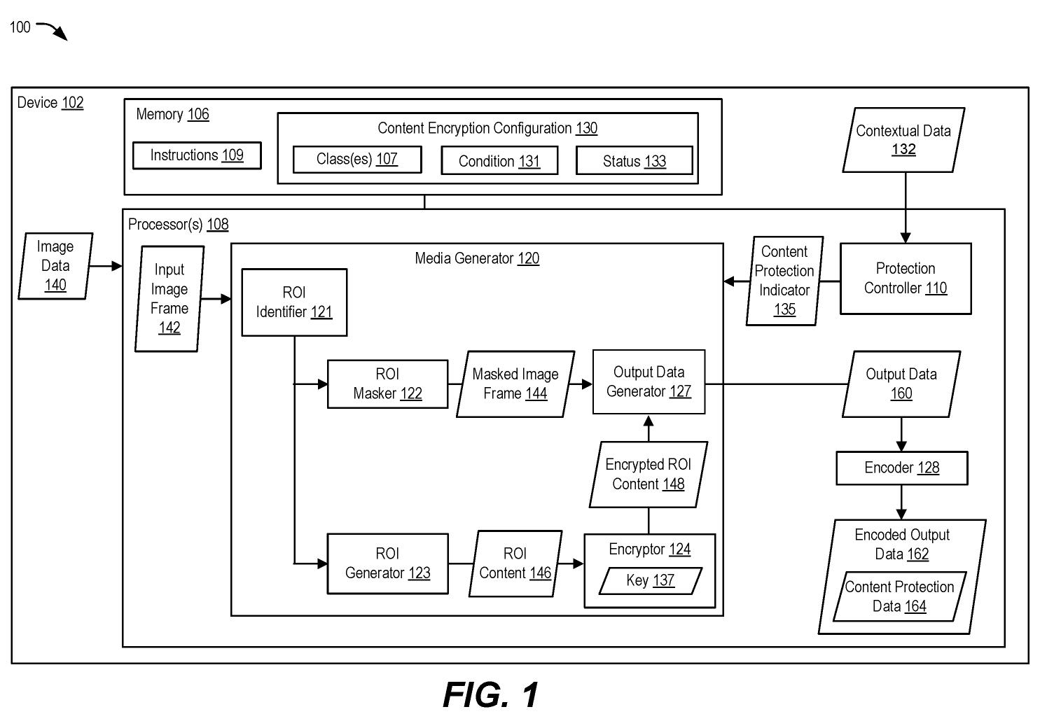

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein - e.g., when no particular one of the features is being referenced, the reference number is used without a distinguishing letter. However, when one particular feature of multiple features of the same type is referred to herein, the reference number is used with the distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows – a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system 100 to identify and encrypt media content, in accordance with one or more aspects of the present disclosure. The system 100 includes a device 102 that is configured to or is operable to identify and encrypt the media content.

The device 102 includes, or is coupled to, a memory 106 (e.g., a memory device) and one or more processors 108 (collectively referred to herein as the “processor 108”). The memory 106 may include one or more memory devices, such as a single memory or multiple different memory devices (of the same type or of different types).

The memory 106 is configured to store instructions 109 and a content encryption configuration 130. The instructions 109, when executed by the processor 108, cause the processor 108 to perform one or more operations as described herein. The content encryption configuration 130 may be associated with or indicate content (e.g., sensitive content) to be protected. The content encryption configuration 130 may be determined by a user of the device 102, by another user (e.g., a contact of the user of the device 102), by a provider (e.g., a service provider or OEM) associated with the device 102, by a company or entity, based on a regulation, or a combination thereof. In some embodiments, the content encryption configuration 130 may be associated with media content generated in association with a surveillance system (e.g., a body camera or a closed circuit camera system), a personal recording (e.g., recorded in a public space or a private space), a vehicle (e.g., for autonomous driving, a dashboard camera, or for in-cabin monitoring), or a combination thereof, as illustrative, non-limiting examples.

The content encryption configuration 130 includes one or more object classes 107 (collectively referred to herein as the “object class 107”), one or more conditions 131 (collectively referred to herein as the “condition 131”), and a status 133. The object class 107 indicates a class or type of one or more objects to be identified or detected within media content. The media content, such as input media content, may include image data, an image frame, video data (e.g., a sequence of multiple image frames), audio data, or a combination thereof. The object class 107 may include or be associated with sensitive, private, proprietary, or confidential content to be protected. In some embodiments, the class or type of the one or more objects may include or indicate a human body, a body part, a particular individual, a human face, a voice, a word or phrase, a sound, a vehicle, a type of vehicle, a vehicle manufacturer, a vehicle model, a vehicle license plate, an address, a street name, a weapon, a type of weapon, an animal, a document, a poster, a display or monitor (e.g., a computer screen or a display device), a whiteboard, a logo or company identifier, or a combination thereof, as illustrative, non-limiting examples. Additionally, or alternatively, the object class 107 includes or indicates all media content, such as an entire image frame, an entire bitstream, all audio content, or a combination thereof.

The condition 131 (e.g., an encryption condition) may indicate or define one or more situations or circumstances in which the object class 107 is to be encrypted. For example, when the condition 131 is satisfied (e.g., the condition 131 is present), an instance of the object class 107 detected within the media content is to be encrypted. Alternatively, when the condition 131 is not satisfied (e.g., the condition 131 is not present) the instance of the object class 107 does not need to be detected within the media content and/or a detected instance of the object class 107 within the media content does not need to be encrypted.

In some embodiments, the condition 131 indicates to encrypt the object class 107 based on a physical space or an environment, such as a physical space or environment associated with an office, a public space, an outdoor space, a restricted area, a geofenced location, or a particular geographic location. Additionally, or alternatively, the condition 131 may indicate to encrypt the object class 107 based on an object, availability of a particular wireless network, a positioning system (e.g., a global positioning system, an indoor positioning system, etc.), or a combination thereof.

In a first example of the content encryption configuration 130, the condition 131 indicates to encrypt the object class 107 based on a physical space associated with an office, availability of a particular wireless network to the device 102, a positioning system (e.g., a location of the device 102 as determined by the positioning system), or a particular geographic location associated with the device 102. Additionally, in the first example of the content encryption configuration 130, the object class 107 includes a document, a whiteboard, a poster, a computer screen, a display device, or a combination thereof. In a second example of the content encryption configuration 130, the condition 131 indicates to encrypt the object class 107 based on the device 102 being located in or associated with a physical space or an environment that is associated with a restricted area. Additionally, in the second example of the content encryption configuration 130, the object class 107 class includes all content of the input media data. In a third example of the content encryption configuration 130, the condition 131 indicates to encrypt the object class 107 based on an environment associated with the device 102 being an outdoor area, a public area, or a combination thereof. Additionally, in the third example of the content encryption configuration 130, the object class 107 includes human faces. In a fourth example of the content encryption configuration 130, the condition 131 indicates to encrypt the object class 107 based on the object class being located on a building, a document, a sign, or a combination thereof. Additionally, in the fourth example of the content encryption configuration 130, the object class 107 includes an address, a street name, or a combination thereof. In a fifth example of the content encryption configuration 130, the condition 131 indicates to encrypt the object class 107 based on the object class being located on a vehicle. Additionally, in the fifth example of the content encryption configuration 130, the object class 107 includes a license plate. It is noted that the examples of the content encryption configuration 130 are provided as non-limiting examples and that other examples of the content encryption configuration 130 (e.g., the condition 131 and/or the object class 107) are possible.

The status 133, such as a status indicator, indicates whether or not the content encryption configuration 130 is active (e.g., whether or not the condition 131 is satisfied). Additionally, or alternatively, the status 133 may include or indicate a time period or duration during which the content encryption configuration 130 is active or during which the condition 131 may be checked to see if it is satisfied. For example, the status 133 may indicate the content encryption configuration 130 can be active for 12 hours. As another example, the status 133 may indicate a time period from 8 am to 5 pm on Mondays and Thursdays. In some embodiments, based on the status 133 indicating that the content encryption configuration 130 is active, the protection controller 110 may monitor for a monitoring period without re-evaluating the condition 131. The monitoring period may be based on a time duration (e.g., a number of seconds or minutes), a number of frames of the input media data (e.g., a predetermined number of image frames), a periodic interval (e.g., every N frames), or a combination thereof. During the monitoring period, the protection controller 110 may continue to detect instances of the object class 107 and encrypt portions of the input media data without re-evaluating the condition 131. After the monitoring period, the protection controller 110 may determine whether to maintain the status 133 as active based on whether an instance of the object class 107 was detected in the input media data during the monitoring period. For example, if the instance of the object class 107 was detected in the input media data during the monitoring period (e.g., in a last frame or a most recent frame of the monitoring period), the protection controller 110 may extend the monitoring period and maintain the status 133 as active. Alternatively, if the instance of the object class 107 was not detected in the input media data during the monitoring period, the protection controller 110 may re-evaluate the condition 131 based on the contextual data 132 and, based on the re-evaluation, maintain the status 133 as active or change the status 133 to inactive. In some embodiments, the protection controller 110 may re-evaluate the condition 131 continuously (e.g., for each frame), periodically (e.g., at a predetermined interval), or based on the monitoring period, depending on a configuration or a power consumption mode of the device 102.

In some embodiments, the content encryption configuration 130 includes or indicates a key. The key may include or correspond to a respective object class 107. The key may be configured to encrypt at least a portion of media content that includes or is associated with an instance of the object class 107, to encrypt another key, decrypt the other encrypted key, or a combination thereof. In an example in which the key includes multiple keys, the key may include a first key (e.g., an encryption key such as the key 137) configured to encrypt at least a portion of media content that includes or is associated with an instance of the object class 107, a second key (e.g., a public key of a public-private key pair) configured to encrypt information (such as the first key), a third key (e.g., a private key of the public-private key pair) configured to decrypt information encrypted using the second key, or a combination thereof.

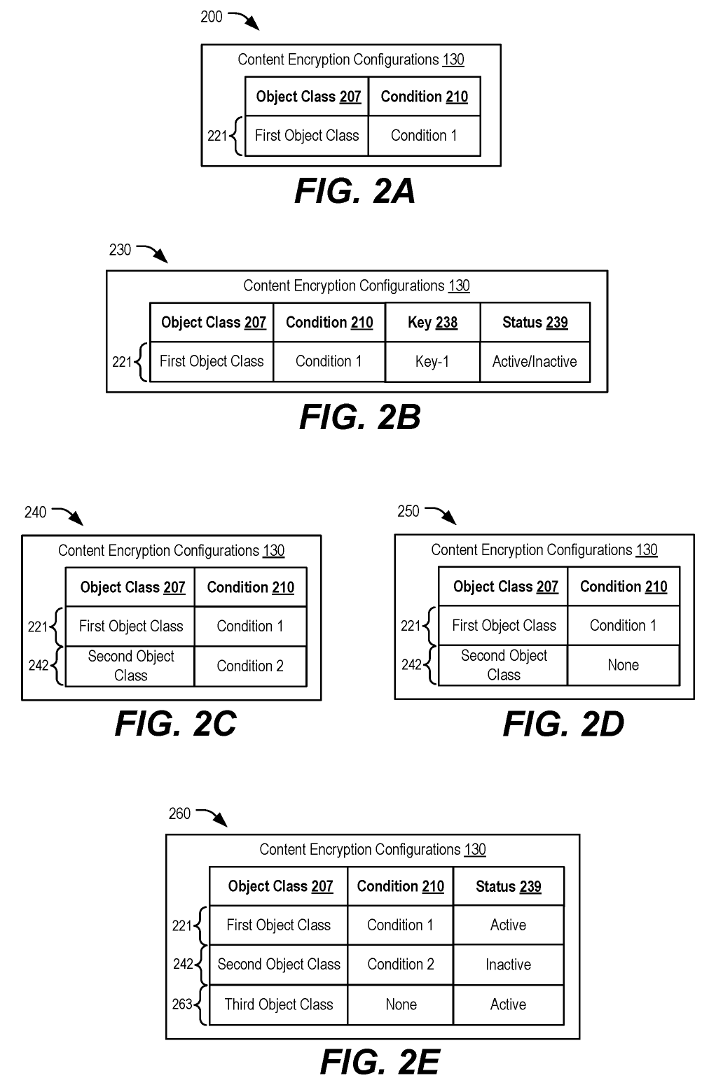

In some embodiments, the content encryption configuration 130 and/or the object class 107 may also include or indicate a model, such as a neural network model, AI model or ML model, to be used to identify or detect a corresponding class or type of one or more objects within media content. In some other implementations, the content encryption configuration 130 may include additional information, such as a source (e.g., an owner) of the content encryption configuration 130. Additionally, or alternatively, it is noted that the content encryption configuration 130 may include one or more configurations. Examples of the content encryption configuration 130 that includes one or more configurations are described further herein at least with reference to FIGS. 2A-2E.

In some embodiments, the content encryption configuration 130 includes multiple configurations (e.g., multiple entries) that originate from different sources, such as a user of the device 102, a contact of the user, a provider associated with the device 102, a company or other entity, a regulation, or a combination thereof. In some embodiments, the content encryption configuration 130 includes or indicates a priority associated with one or more of the multiple configurations. The priority may be determined based on the source of the respective configuration (e.g., a regulation-based configuration may have a higher priority than a company-based configuration, which may have a higher priority than a personal or contact-based configuration), based on a sensitivity level associated with the respective object class 107, based on a geographic or contextual scope associated with the respective configuration, based on a user-defined ranking, based on a recency of provisioning of the respective configuration, or a combination thereof. In some embodiments, the priority is included as a field of an entry of the content encryption configuration 130, similar to or in addition to the object class 207, the condition 210, the key 238, and the status 239 described further herein at least with reference to FIGS. 2A-2E. In some embodiments, the priority of a configuration of the content encryption configuration 130 is context-bounded, such that the configuration has a first priority when the device 102 is associated with a particular context (e.g., when the contextual data 132 indicates that the device 102 is in a particular geographic location, is connected to a particular network, is in a particular environment, or a combination thereof) and has a second priority that is different than the first priority when the device 102 is not associated with the particular context. For example, the protection controller 110 may elevate a priority of a corporate configuration when the device 102 is determined to be at a particular facility based on the contextual data 132, such that the corporate configuration controls over a personal configuration within the facility and the personal configuration controls outside the facility.

In some embodiments, the protection controller 110 is configured to evaluate compatibility between two or more configurations of the content encryption configuration 130 that are simultaneously active (e.g., that each have a status 239 indicating active). For example, the protection controller 110 may determine that two or more configurations are compatible (e.g., the configurations have non-overlapping object classes 207 or non-conflicting encryption settings such that each of the configurations may be applied independently of one or more other of the configurations), incompatible (e.g., the configurations indicate different keys 238 for a same object class 207, indicate different conditions 210 for a same object class 207, indicate different mask techniques for a same object class 207, indicate overlapping object classes 207 that result in overlapping regions of interest within the input image frame 142, indicate conflicting encrypt-or-do-not-encrypt settings for a same object class 207, or a combination thereof), or that a first configuration is subsumed by a second configuration (e.g., the first configuration applies broadly to an object class 207 and the second configuration applies to a narrower subset of the same object class 207). Compatible configurations may be applied independently of one another, and incompatible configurations may be processed using a conflict resolution rule.

In some embodiments, the protection controller 110 is configured to resolve a conflict between two or more configurations of the content encryption configuration 130 based on a conflict resolution rule. The conflict resolution rule may include a strict priority rule (e.g., a configuration having a highest priority among the conflicting configurations controls, and one or more lower-priority configurations are not applied for the conflicting entry), a most-restrictive rule (e.g., the encrypted ROI content 148 is generated based on a most-restrictive of the conflicting configurations, such that the ROI is encrypted if any one of the conflicting configurations indicates that encryption is required for the ROI), a compound encryption rule (e.g., ROI content corresponding to the ROI is encrypted using multiple keys 238 corresponding to the conflicting configurations, in series or in parallel, such that the encrypted ROI content 148 is decryptable based on a private key associated with any one of the conflicting configurations), a subsumption rule (e.g., a narrower of the conflicting configurations applies within a scope of the narrower configuration and a broader of the conflicting configurations applies outside the scope of the narrower configuration), or a combination thereof. The conflict resolution rule may be indicated by the content encryption configuration 130, the content protection indicator 135, or a combination thereof. In some embodiments, the encoded output data 162 includes the content protection data 164 that indicates one or more of the configurations of the content encryption configuration 130 that contributed to generation of the encrypted ROI content 148, such that the content protection data 164 enables identification of which of multiple active configurations was applied to generate the encrypted ROI content 148.

In some embodiments, the content encryption configuration 130 includes or indicates, for one or more entries of the content encryption configuration 130, a designation of an entry as required or preferred. A required entry may be applied when the corresponding condition 210 is satisfied regardless of conflicts with one or more other entries, and a preferred entry may be applied when the corresponding condition 210 is satisfied and when the preferred entry does not conflict with one or more required entries. In some embodiments, two or more required entries from different sources are applied cumulatively, and one or more preferred entries are applied only when compatible with one or more active required entries. In some embodiments, the priority of one or more configurations of the content encryption configuration 130 is user-configurable, such that a user of the device 102 is able to adjust an order or ranking of the one or more configurations (e.g., via a user interface of the device 102). In some embodiments, the user configurability is tiered, such that one or more configurations are not user-modifiable (e.g., a regulation-based configuration is fixed and is not modifiable by the user of the device 102) and one or more other configurations are user-modifiable within one or more constraints imposed by the one or more non-user-modifiable configurations (e.g., a corporate configuration is reorderable within a corporate-permitted range but is not reorderable above a regulation-based configuration, and a personal configuration is fully user-configurable).

In some embodiments, the protection controller 110 is configured to determine that a conflict exists between two or more configurations of the content encryption configuration 130 and to generate a notification (e.g., to be provided via a user interface of the device 102) of the conflict. In some embodiments, the protection controller 110 is configured to apply a default conflict resolution rule without user intervention based on a determination of the conflict. In some other embodiments, the protection controller 110 is configured to prompt a user of the device 102, via the user interface, to select a conflict resolution rule from among multiple conflict resolution rules or to override a default conflict resolution rule, where an ability of the user to override the default conflict resolution rule may be limited based on the tiered user configurability described above (e.g., the user is permitted to override the default conflict resolution rule for one or more personal configurations and is not permitted to override the default conflict resolution rule for one or more regulation-based configurations).

In some examples, the memory 106 stores other information or data, such as media content. The media content can include or indicate audio content, video content, or a combination thereof. In some examples, the stored media content includes at least an encrypted portion.

The processor 108 includes a protection controller 110, a media generator 120, and an encoder 128. Each of the protection controller 110, the media generator 120, and the encoder 128, or a portion thereof, may be implemented by the processor 108 executing instructions (e.g., software), dedicated hardware (e.g., circuitry), or a combination thereof. It is noted that in some embodiments, two or more of the protection controller 110, the media generator 120, or the encoder 128 may be combined. For example, the media generator 120 may include the protection controller 110, the encoder 128, or both.

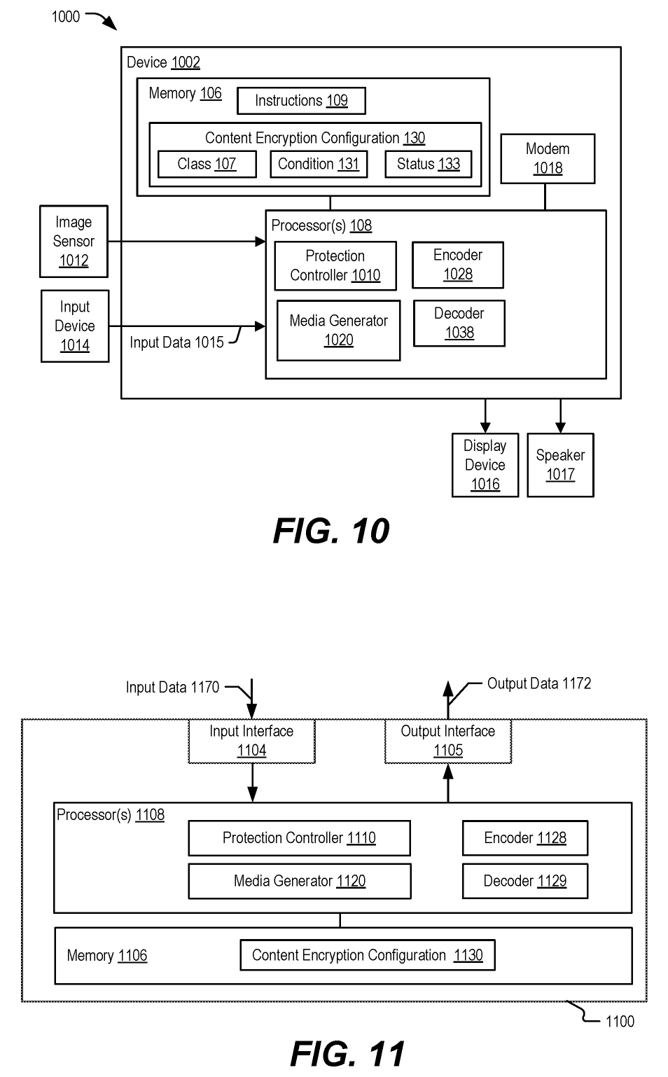

The protection controller 110 is configured to provide a content protection indicator 135 to the media generator 120 for the media generator 120 to implement an encryption requirement. The content protection indicator 135 may indicate the encryption requirement that includes the object class 107, an encryption key (e.g., the key 137), or a combination thereof, to be applied by the media generator 120 to identify or detect, and encrypt, media content to be protected. In some embodiments, the content protection indicator 135 may indicate a list of object classes 107 and, for each object class, a key associated with an instance of the object class. Additionally, or alternatively, the protection controller 110 is configured to program or configure the encoder 128. In some implementations, the protection controller 110 may generate the content protection indicator 135 based on an input (as described with reference to FIG. 10), location data that indicates a location of the device 102, the content encryption configuration 130 or the status 133 (e.g., an active status) thereof, or a combination thereof.

In some embodiments, the protection controller 110 is configured to obtain contextual data 132. For example, the contextual data (e.g., contextual information) may include or indicate position data associated with the device 102, a wireless network identifier, an environment associated with the input media data, an object included in the input media data, or a combination thereof. In some embodiments, the protection controller 110 obtains the contextual data 132 from a positioning system, map data, a wireless network detector, an object detector (e.g., a region of interest (ROI) identifier 121) configured to detect a conditional object included in the media content, or a combination thereof.

The protection controller 110 may be configured to determine whether the condition 131 is satisfied based on the contextual data 132. In some embodiments, the protection controller 110 is configured to access the content encryption configuration 130 and determine whether the condition 131 is satisfied based on the contextual data 132. Additionally, or alternatively, the protection controller 110 may determine whether the status 133 of the content encryption configuration 130 is inactive or active. If the content encryption configuration 130 is inactive and the protection controller 110 determines that the condition 131 is satisfied, the protection controller 110 may change the status 133 from inactive to active. Alternatively, if the content encryption configuration 130 is active and the protection controller 110 determines that the condition 131 is not satisfied, the protection controller 110 may change the status 133 from active to inactive. The protection controller 110 is configured to generate the content protection indicator 135 based on the condition 131 being satisfied, based on the status 133 of the content encryption configuration 130 being active, or a combination thereof.

In an illustrative example, determining whether the condition 131 is satisfied may include comparing the position data (e.g., coordinates of the device 102 obtained from a positioning system, such as a global positioning system or an indoor positioning system) to a defined geographic boundary associated with the condition 131, such as a geofence polygon, and determining that the condition 131 is satisfied based on the position data indicating that the device 102 is within the defined geographic boundary. In another illustrative example, determining whether the condition 131 is satisfied may include comparing a wireless network identifier (e.g., a service set identifier (SSID) or a basic service set identifier (BSSID) of a detected wireless network) to one or more wireless network identifiers associated with the condition 131, and determining that the condition 131 is satisfied based on the wireless network identifier matching one of the one or more wireless network identifiers associated with the condition 131. In yet another illustrative example, determining whether the condition 131 is satisfied may include detecting, by the object detector (e.g., the ROI identifier 121), a conditional object included in the input media data, and determining that the condition 131 is satisfied based on the detection of the conditional object. For example, the conditional object may include a sign, a marker, or a beacon that indicates a requirement to encrypt one or more object classes.

In some embodiments, the protection controller 110 is configured to obtain an encryption key, such as the key 137, based on the condition 131 being satisfied, based on the status 133 of the content encryption configuration 130 being active, or a combination thereof. For example, the protection controller 110 may obtain the key 137 from the memory 106 (e.g., from the content encryption configuration 130). As another example, the protection controller 110 may generate the key 137, such as an encryption key for a respective object class 107. In some such examples, the protection controller 110 may store the key 137 at the memory 106, indicate the key 137 by the content protection indicator 135, or a combination thereof. In some embodiments, the protection controller 110 obtains the key 137 in association with a respective object class 107, and the key 137 is included in the content protection indicator 135 (provided to the media generator 120) and the key 137 is not provided to the memory 106. In such embodiments, the key 137 is not stored as part of the content encryption configuration 130.

In some embodiments, the key 137 is or includes a value that may be used by an algorithm or process to encrypt media content, decrypt encoded media content, or a combination thereof. To illustrate, in some examples, the same key 137 is used to encrypt at least a portion of the media content to generate encrypted media content, and to decrypt the encrypted media content to recover the portion of the media content (e.g., an unencrypted version of the portion).

The media generator 120 is configured to identify and encrypt media data based on the content protection indicator 135 – e.g., in accordance with a content encryption configuration 130 indicated by the content protection indicator 135. The media generator 120 includes an ROI identifier 121, an ROI masker 122, an ROI generator 123, an encryptor 124, and an output data generator 127.

The ROI identifier 121 is configured to process media content to detect the object class 107 included in media content, such as an input image frame 142, and identify an ROI associated with the detected object class. In an example, the ROI identifier 121 processes media content to detect when an object having the object class 107 is in the media content; to illustrate, the ROI identifier may include a face detector configured to detect a person’s face – e.g., a “face” object class - in the media content. The ROI may include at least a portion of an image frame, or a time period or frequency of an audio signal. For example, the ROI may include an outline of the detected object class or a region that is larger than the detected object class.

In some embodiments, to detect the object class 107 and/or to identify the ROI, the ROI identifier 121 may use a model (e.g., a neural network model, an AI model, or an ML model), a histogram of gradient methods combined with support vector machine (SVM), a bounding box output, or dense pixel segmentation, as illustrative, non-limiting examples. In some embodiments, the ROI identifier 121 may be configured to generate position data that indicates a position of the ROI and/or a detected object class within the media content. As illustrative, non-limiting examples, the position data may include or indicate a pixel coordinate, multiple pixel coordinates, or a bounding box. Additionally, or alternatively, the ROI identifier 121 may be configured to perform a segmentation operation to generate segmentation data that includes or indicates a portion of the media content, where the portion includes a detected instance of the object class 107. For example, the segmentation operation can be configured to identify, in an image, which pixels belong to an identified object (and which pixels do not belong to the identified object) and to generate segmentation data that includes, for each pixel identified as belonging to the object, an indication that the pixel is part of the object. In a particular embodiment, the segmentation data includes a segmentation frame having pixels of a first value (e.g., 255, or an all-1 value) to indicate pixels in the image that belong to a detected object class 107 and pixels of a second value (e.g., 0, or an all-0 value) to indicate pixels in the image that do not belong to the detected object class 107.

In some embodiments, the ROI identifier 121 is configured to detect a conditional object, such as a conditional object that is indicated by the condition 131. Based on detection of the conditional object in the media content, the ROI identifier 121 may generate the contextual data 132 that indicates detection of the conditional object.

The ROI masker 122 is configured to mask the ROI (e.g., the portion of the media content) identified by the ROI identifier 121. The ROI masker 122 may mask the ROI using one or more techniques (e.g., a mask type), such as blurring using uniform kernels or gaussian kernels, masking the region a solid color (e.g., black or white), masking the region with a pattern (e.g., stripes), masking the region with an encrypted version of the ROI (e.g., encrypted pixel values that appear to be random noise in the ROI), or a combination thereof. In some embodiments, the ROI masker 122 masks the ROI in the media content to generate a masked version of the media content. In some embodiments, the ROI masker 122 is configured to receive a mask indicator which indicates a mask technique or a mask type to be used by the ROI masker 122. The mask indicator may be received from the protection controller 110. For example, the content protection indicator 135 may include or indicate the mask indicator.

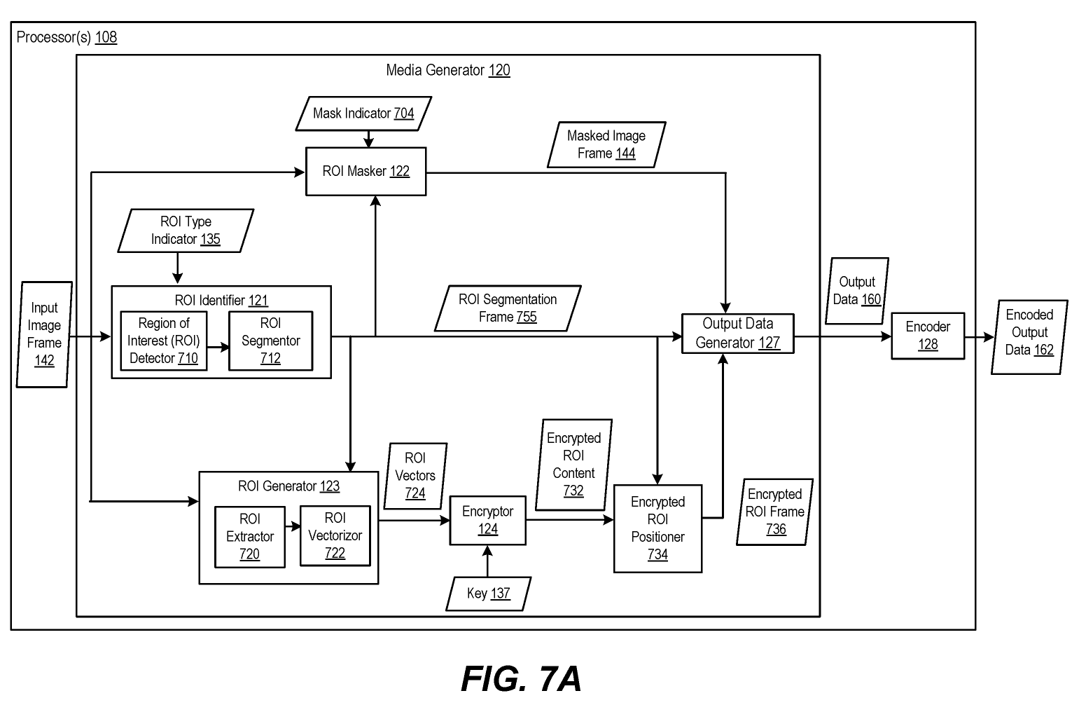

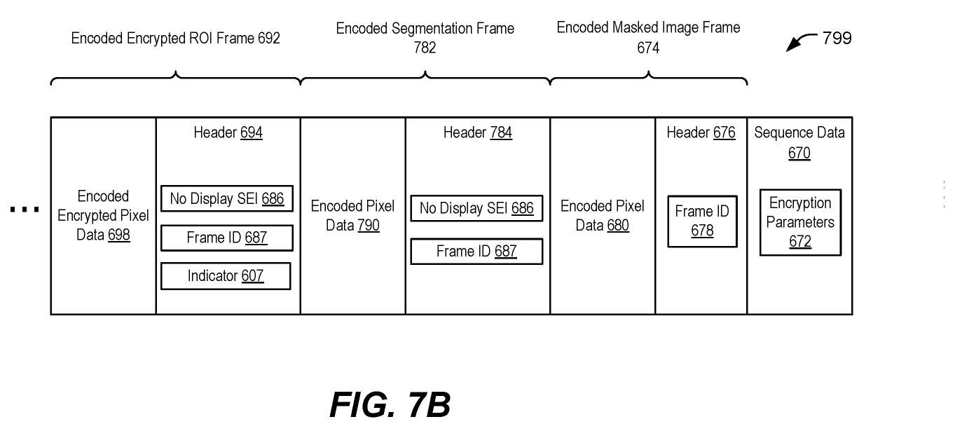

The ROI generator 123 is configured to obtain ROI content 146 included in the ROI (e.g., the portion of the media content) identified by the ROI identifier 121. For example, the ROI generator 123 may copy or extract the ROI content 146 from the media content based on the ROI identified by the ROI identifier 121. One or more operations that may be performed by the ROI generator 123 to obtain the ROI content 146 are described further herein at least with reference to FIG. 7A. In some embodiments, the ROI content 146 includes a vectorized representation (e.g., a one-dimensional array of data (vector)) that is suitable for encryption.

The encryptor 124 is configured to encrypt the ROI content 146 to generate encrypted ROI content 148. For example, the encryptor 124 may encrypt the ROI content 146 based on or using the key 137. In some embodiments, the encryptor 124 uses a format preserving encryption (input and output have the same size) to generate the encrypted ROI content 148 based on the ROI content 146. Illustrative, non-limiting examples of a format preserving encryption include format-preserving, Feistel-based encryption (FFX), such as FF1 or FF3. In some embodiments, one or more encryption parameters, such as a block size or an alphabet, to be used by the encryptor 124 may be obtained from the content encryption configuration 130, the content protection indicator 135, or a combination thereof.

In some embodiments, the encryptor 124 is configured to encrypt the key 137 to generate an encrypted key. For example, the encryptor 124 may encrypt the key 137 using a key, such as a public key of a public-private key pair. The encrypted key may be provided to the output data generator 127, the encoder 128, the protection controller 110, the memory 106, or a combination thereof.

The output data generator 127 is configured to generate output data 160 that includes or is based on the masked image frame 144, the encrypted ROI content 148, or a combination thereof. In some implementations, the output data 160 includes the masked image frame 144 and not the encrypted ROI content 148. In other implementations, the output data 160 includes the encrypted ROI content 148 and not the masked image frame 144. In some embodiments the output data generator 127 is configured to combine the masked image frame 144, the encrypted ROI content 148, position data or segmentation data associated with a position of the portion of the media content that corresponds to the ROI, one or more encoder parameters, or a combination thereof, to generate the output data 160. In some embodiments, to generate the output data 160, the output data generator 127 is configured to concatenate the masked image frame 144, the encrypted ROI content 148, position data or segmentation data associated with a position of the portion of the media content that corresponds to the ROI, one or more encoder parameters, or a combination thereof. It is noted that when the media content includes video content, masked image frames (e.g., the masked image frame 144) and encrypted ROI content (e.g., the encrypted ROI content 148) may be temporally concatenated and provided to the encoder 128 for processing and/or compression.

The encoder 128 is configured to receive the output data 160 and generate encoded output data 162. In some embodiments, the encoder 128 may encode the output data 160 based on the content protection indicator 135, one or more encoder parameters received from the protection controller 110 and/or the media generator 120, or a combination thereof. In a particular embodiment, the encoder 128 uses a higher-compression, lossy encoding to encode the masked image frame 144 in the output data 160 and switches to a lower-compression, lossless encoding technique to encode the encrypted ROI content 148 in the output data 160.

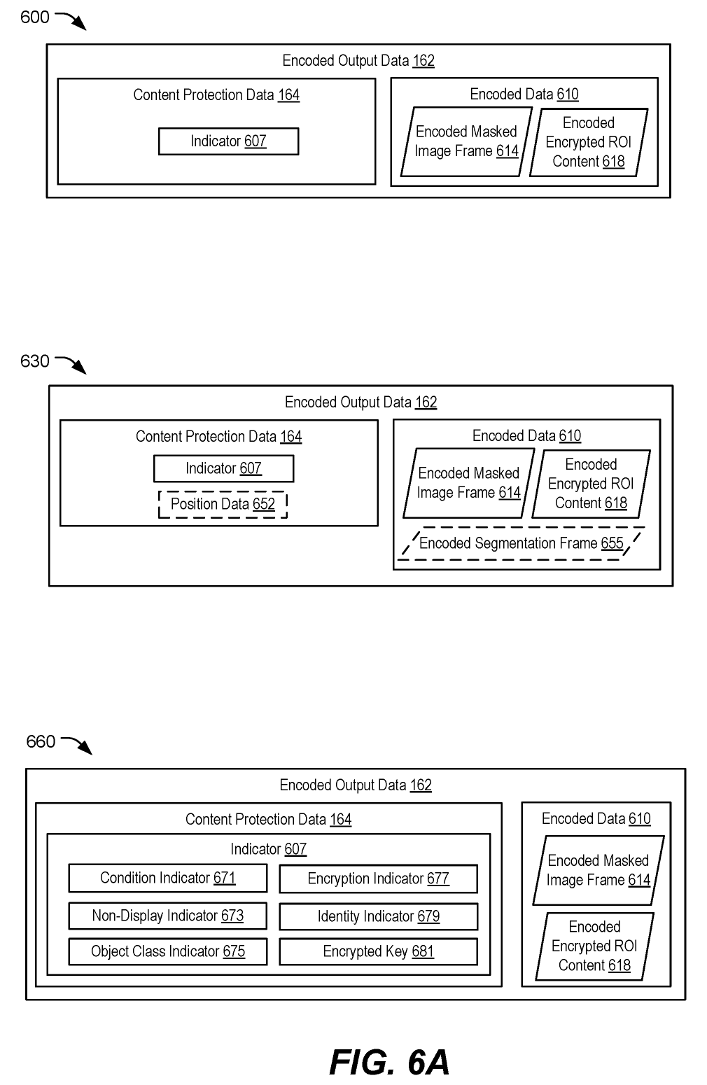

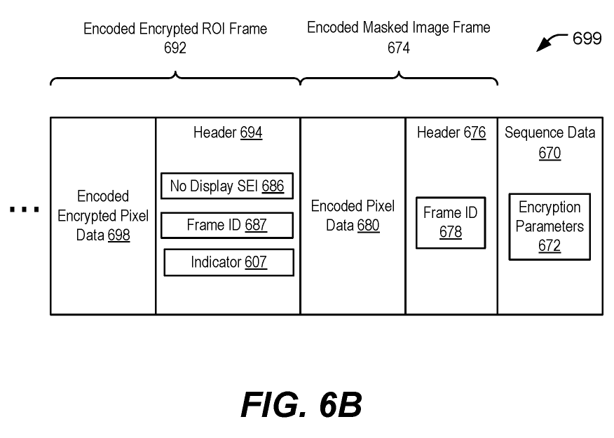

In some embodiments, the encoded output data 162 includes encoded data that includes or corresponds to the masked image frame 144, the encrypted ROI content 148, the output data 160, or a combination thereof. Examples of the encoded data are described further herein at least with reference to FIG. 6A.

In a particular embodiment, the encoded output data 162 includes content protection data 164. In some embodiments, the content protection data 164 may include one or more indicators, the key 137, an encrypted version of the key 137, or a combination thereof. Examples of the one or more indicators are described further herein at least with reference to FIG. 6A. In an illustrative example, the one or more indicators may include an encryption indicator that indicates that the encoded output data 162 includes or indicates the encrypted ROI content 148 (e.g., encrypted media data). For example, the encryption indicator may include or correspond to a flag that indicates the presence of encrypted data in the encoded output data 162. Additionally, or alternatively, the encryption indicator may indicate one or more encryption parameters. The one or more encryption parameters may include or indicate an encryption type, a maximum block size, an alphabet size, one or more formatting details, a number of object classes, or a combination thereof. In some embodiments, the one or more indicators include an identity indicator, a non-display indicator, position data, an object class indicator, or a combination thereof.

In some embodiments, the encoded output data 162 includes a bitstream. The bitstream may be compliant with a standard, such as H.264/MPEG-4 AVC (Advanced Video Coding), H.265/HEVC (High Efficiency Video Coding), MPEG-2, MPEG-1, VC-1 (Windows Media Video). Additionally, or alternatively, the bitstream may include other information. The other information may include or indicate extra information, such as a header, metadata, segmentation data (e.g., a segmentation frame), the encrypted ROI content 148, the masked image frame 144, the key 137, an encrypted version of the key 137 (e.g., encrypted based on the public key), or a combination thereof.

In a particular embodiment, the content protection data 164 is included in a header of the encoded output data 162, metadata of the encoded output data 162, or a combination thereof. In some embodiments, the encoded output data 162 is included in or corresponds to a bitstream, such as the bitstream 699 described further herein with reference to FIG. 6B or the bitstream 799 described further herein with reference to FIG. 7B. In other embodiments, the encoded output data 162 is included in or corresponds to a media container, such as an MPEG-4 (MP4) container, an Audio Video Interleave (AVI) container, an MPEG transport stream container, or another multimedia container format. The media container may be configured to encapsulate components of the encoded output data 162, such as one or more encoded masked image frames (e.g., the encoded masked image frame 614 described further herein with reference to FIG. 6A), encrypted data such as one or more encoded encrypted ROI frames (e.g., the encoded encrypted ROI content 618 described further herein with reference to FIG. 6A), the content protection data 164, segmentation data such as one or more encoded segmentation frames (e.g., the encoded segmentation frame 655 described further herein with reference to FIG. 6A), or a combination thereof.

In an illustrative example, the media container includes multiple tracks (or, in some container formats, multiple streams), such that a first track of the media container includes the encoded masked image frame 614 and a second track of the media container includes the encoded encrypted ROI content 618. Additionally, or alternatively, the content protection data 164, the segmentation data, or both, may be included in a metadata field of the media container, a supplemental track of the media container, an embedded data field of the media container, or a combination thereof. In some embodiments, the media container provides an alternative to including the encrypted ROI content 148, the segmentation data, or the content protection data 164 within a codec-level bitstream (e.g., the bitstream 699 of FIG. 6B or the bitstream 799 of FIG. 7B), such that the data associated with encryption and content protection is carried at a container level rather than within codec-compliant frame headers or sequence data. In some embodiments in which the encoded output data 162 includes the media container, the output data generator 127, the encoder 128, or both, are configured to operate at a container level to organize the masked image frame 144, the encrypted ROI content 148, the segmentation data, and the content protection data 164 as distinct data elements (e.g., tracks, metadata entries, or embedded data fields) within the media container. Use of the media container can support file-based storage and offline playback workflows in addition to streaming, by encapsulating the encoded components in a single container file that can be stored, transferred, or accessed at a later time.

The segmentation data may include or correspond to a segmentation frame that is encoded by the encoder 128 as a no display frame (e.g., using a no display supplemental enhancement information (SEI) message). The encrypted ROI content 148 may be encoded by the encoder 128 as a no display frame (e.g., using a no display SEI message). The one or more indicators may include an encryption indicator that indicates that the encrypted ROI content 148 is included in the bitstream, an encryption standard used by the encryptor 124, or both.

During operation of the system 100, the processor 108 receives media content, such as the image data 140. Additionally, or alternatively, the media content may include audio data. The media content, such as image data, audio data, or a combination thereof, may be received from a source device (e.g., a microphone or a camera) or from the memory 106. The image data 140 may include an image frame, such as the input image frame 142. In some embodiments, the image data 140 includes video data, such as a series of image frames including the input image frame 142. The processor 108 provides the input image frame 142 to the media generator 120 (e.g., the ROI identifier 121).

The processor 108 (e.g., the protection controller 110) may obtain the contextual data 132 associated with the image data 140 and/or the device 102. The processor 108 (e.g., the protection controller 110) may determine whether the condition 131 is satisfied based on the contextual data 132. Based on the condition 131 being satisfied, the protection controller 110 may set the status 133 to active and/or may generate the content protection indicator 135 that indicates to detect an instance of the object class 107 included in the image data 140 and to encrypt at least a portion of the image data 140 that includes the instance of the object class 107. The protection controller 110 provides the content protection indicator 135 to the media generator 120.

The ROI identifier 121 is configured to detect an instance of the object class 107 included in the input image frame 142 and identify an ROI associated with the detected instance of the object class 107 – e.g., a portion of the input image frame 142 that includes the detected instance of the object class 107. For example, the ROI identifier 121 may detect the instance of the object class 107 based on the content protection indicator 135 indicating to detect the object class 107 in the image data 140 (e.g., in the input image frame 142). Based on the ROI, the ROI masker 122 masks the ROI (e.g., the portion of the input image frame 142) to generate the masked image frame 144. Additionally, based on the ROI, the ROI generator 123 generates the ROI content 146, which is encrypted by the encryptor 124 to generate the encrypted ROI content 148.

The output data generator 127 generates the output data 160 based on the masked image frame 144, the encrypted ROI content 148, or a combination thereof. For example, the output data generator 127 may combine the masked image frame 144 and the encrypted ROI content 148 to generate the output data 160. In some such examples, the output data generator 127 may concatenate the masked image frame 144 and the encrypted ROI content 148, or may modify the masked image frame 144 such that a masked portion of the masked image frame 144 includes the encrypted ROI content 148. Although the media generator 120 is described as including the output data generator 127, in other implementations, the media generator 120 may not include the output data generator 127 and the masked image frame 144 and the encrypted ROI content 148 may be provided to the encoder 128.

The encoder 128 generates output media data (e.g., the encoded output data 162) that includes or indicates the masked image frame 144, the encrypted ROI content 148, or a combination thereof. In some embodiments, the encoded output data 162 includes the content protection data 164 that includes one or more indicators. Additionally, or alternatively, the encoded output data 162 (e.g., the content protection data 164) includes a non-display indicator associated with the encrypted media data.

The processor 108 may provide the encoded output data 162 to the memory 106 for storage. Additionally, or alternatively, the processor 108 may send the encoded output data 162 to a decode device of the device 102 or to another device (e.g., a remote device) that includes a decoder.

In some embodiments, the media generator 120 (e.g., the ROI identifier 121) is configured to generate, based on the input image frame 142 and detection of an instance of the object class 107 in the input image frame 142, segmentation data. Generation of the segmentation data (e.g., a segmentation frame) is described further herein at least with reference to FIG. 7A.

In some embodiments, a device (e.g., the device 102) includes a memory (e.g., the memory 106) and one or more processors (e.g., the processor 108). The memory is configured to store a content encryption configuration (e.g., the content encryption configuration 130) that indicates an object class (e.g., the object class 107), an encryption condition (e.g., the condition 131), and a status (e.g., the status 133). The one or more processors are configured to obtain contextual information (e.g., the contextual data 132) associated with input media data (e.g., the image data 140 or the input image frame 142), and determine whether the encryption condition is satisfied based on the contextual information. The one or more processors are also configured to, based on a determination that the encryption condition is satisfied, change the status of the content encryption configuration to active. The one or more processors are also configured to encrypt, based on an encryption key (e.g., the key 137), a portion of the input media data that includes the instance of the object class to generate encrypted media data (e.g., encrypted ROI content 148).

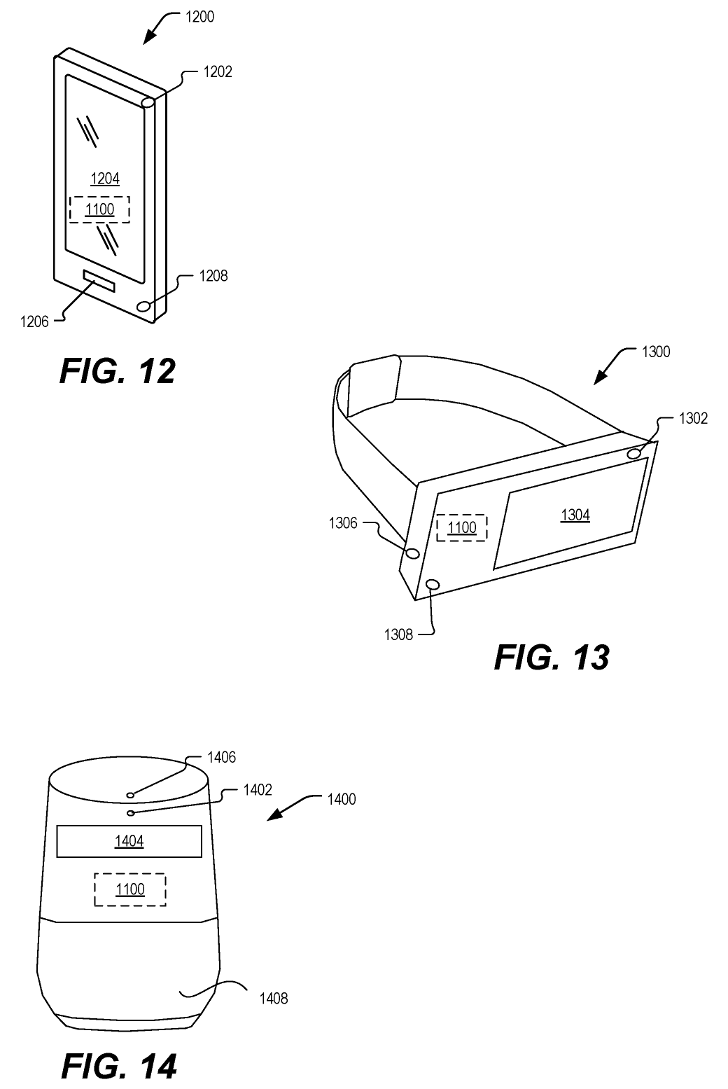

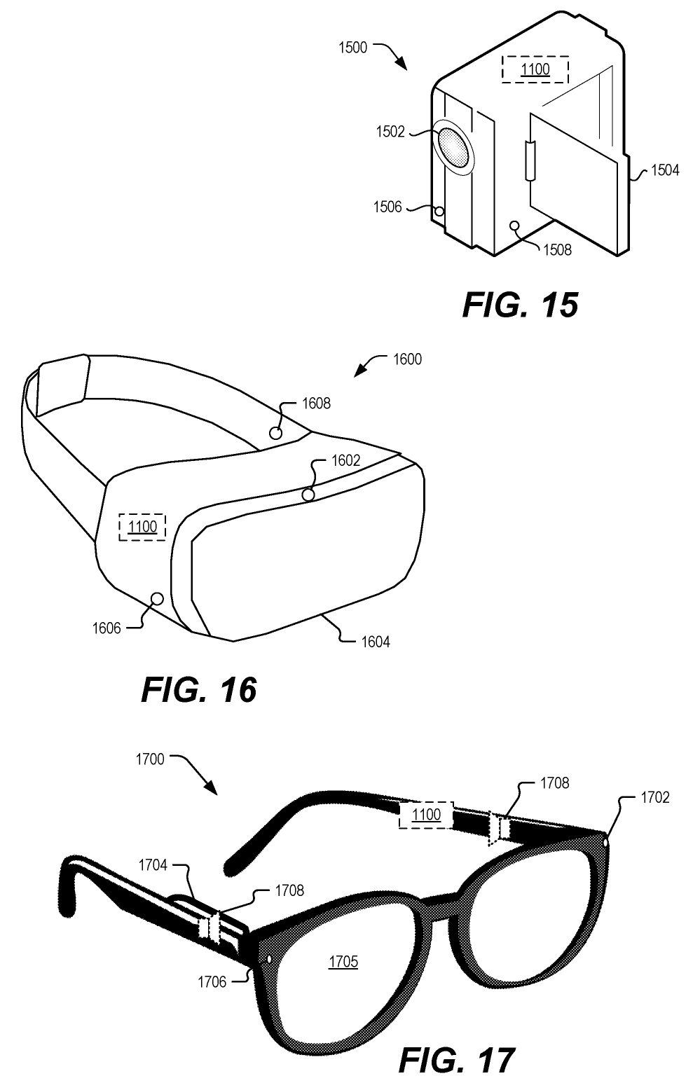

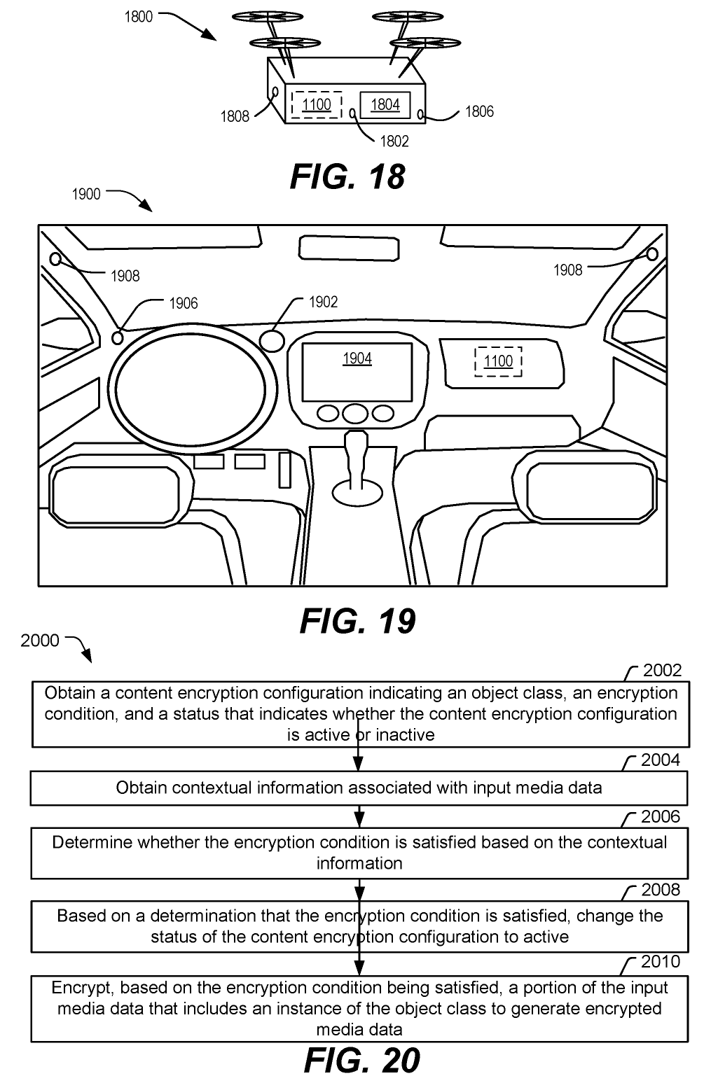

In some examples, the device 102 corresponds to or is included in one of various types of devices, such that the processor 108 can be integrated in multiple types of devices. In an illustrative example, the processor 108 is integrated in a wearable electronic device as depicted in FIG. 13, a virtual reality, mixed reality, or augmented reality headset as depicted in FIG. 16, a mixed reality or augmented reality glasses device as described with reference to FIG. 17, or another wearable device. In another illustrative example, the processor 108 is integrated in a mobile device (a mobile phone or a tablet computer device) as depicted in FIG. 12, a voice-controlled speaker system as depicted in FIG. 14, a camera as depicted in FIG. 15, a vehicle as depicted in FIGS. 18 or 19 , a computer (e.g., a laptop computer) or a server, or another system or device.

As described with reference to FIG. 1, the present disclosure provides techniques for supporting identification and encryption of media content. For example, one technical advantage of implementing the device 102 as described above is that privacy control and content management is provided by identification of the ROI (associated with an instance of the object class 107) of the input image frame 142, and encryption of at least the portion the input image frame 142 based on the ROI. The ROI (associated with an instance of the object class 107) may be identified based on or in response to the condition 131 of the content encryption configuration 130 being satisfied. In some aspects, the condition 131 may be determined to be satisfied based on the contextual data 132. To further illustrate the technical advantage, sensitive, private, or confidential content to be protected in the input image frame 142 is masked based on the ROI to generate the masked image frame 144, which can be displayed by one or more device or users that do not have authorization or access to the sensitive content (e.g., the encrypted ROI content). A user or a device that has access to a decryption key can decrypt the encrypted portion and thereby recover the sensitive content and combine the recovered sensitive content with the masked content to generate (e.g., recreate) the original content. In some embodiments, the operations described with reference to the system 100 may be applied to provide automatic sensitive content (partial video) encryption while the video is captured for the first time. The partial video encryption can allow for both authorized and non-authorized access of encrypted content using the same encoded output data 162 (e.g., the same encrypted bitstream).

FIGS. 2A-2E are diagrams of example of content encryption configurations associated with the system of FIG. 1, in accordance with one or more aspects of the present disclosure. For example, FIG. 2A is a first example 200, FIG. 2B is a second example 230, FIG. 2C is a third example 240, FIG. 2D is a fourth example 250, and FIG. 2E is a fifth example 260. The content encryption configurations 130 of FIGS. 2A-2E may include a data structure, such as a table, that is stored at the memory 106. Although the data structure is described as having a format of a table (having columns and rows), in other embodiments, the data structure can be a different format other than a table.

The content encryption configurations 130 of FIGS. 2A-2E each includes headings. For example, each of the examples of FIGS. 2A-2E includes the headings of an object class 207 and a condition 210, the second example 230 of FIG. 2B also includes the headings of a key 238 and a status 239, and the fifth example 260 of FIG. 2E also includes the heading of the status 239. The object class 207 and the condition 210 may include or correspond to the object class 107 and the condition 131, respectively. The key 238 may include or correspond to a key, such as a public key (of a public-private key pair), a private key (of the public-private key pair), an encryption key (e.g., the key 137), or a combination thereof. The status 239 may include or correspond to the status 133. The status 239 may indicate whether or not an entry (e.g., a respective content encryption configuration) is active or inactive. In some embodiments, the status 239 of an entry may indicate whether or not the respective condition 210 of the entry is satisfied or unsatisfied – e.g., satisfied based on contextual data associated with an input image frame.

It is noted that the headings of the examples of FIGS. 2A-2E are not intended to be limiting and that each of the examples may include headings as described with a different example of the examples of FIGS. 2A-2E. Additionally, or alternatively, one or more of the examples of FIGS. 2A-2E may include one or more different headings than described with reference to FIGS. 2A-2E. For example, another heading may include or indicate a model (e.g., to detect a respective object class), a source of a respective entry (e.g., a respective content encryption configuration), a priority of a respective entry, a designation of a respective entry as required or preferred, or another heading.

Additionally, the content encryption configurations 130 of FIGS. 2A-2E each includes one or more entries. For example, the first example 200 of FIG. 2A and the second example 230 of FIG. 2B each include a first entry 221, the third example 240 of FIG. 2C and the fourth example 250 of FIG. 2D each include the first entry 221 and a second entry 242, and the fifth example 260 of FIG. 2E includes the first entry 221, the second entry 242, and a third entry 263. Each entry of the examples of FIGS. 2A-2E may include multiple fields, where each field corresponds to a different heading of the respective entry. It is noted that each of the examples of FIGS. 2A-2E may have a single entry or multiple entries.

Referring to the first example 200 of FIG. 2A, the first entry 221 includes a first object class for a field of the object class 207, a first condition (Condition 1) for a field of the condition 210. Referring to the second example 230 of FIG. 2B, as compared to the first example 200 of FIG. 2A, the second example 230 includes the additional headings of the key 238 and the status. Accordingly, the first entry 221 includes the first object class for a field of the object class 207, the first condition (Condition 1) for a field of the condition 210, a first key (Key-1) for a field of the key 238, and a first status (of Active or Inactive) for a field of the status 239.

Referring to the third example 240 of FIG. 2C and the fourth example 250 of FIG. 2D, as compared to the first example 200 of FIG. 2A, the third example 240 and the fourth example 250 each includes the first entry and the second entry 242. The first entry 221 of FIG. 2A is the same in each of FIGS. 2A, 2C, and 2D, . The second entry 242 of the examples of each of FIGS. 2C and 2D includes a second object class for a field of the object class 207. The second object class (of the second entry 242) may be the same object class or a different object class as the first object class (of the first entry 221). The second entry 242 of the third example 240 of FIG. 2C also includes a second condition (Condition 2) and the second entry 242 of the fourth example 250 of FIG. 2D indicates that no condition (None) is applicable to the second entry 242. With reference to the third example 240 of FIG. 2C, the second condition (Condition 2 of the second entry 242) may be the same condition or a different condition as the first condition (Condition 1 of the first entry 221).

Referring to the fifth example 260 of FIG. 2E, the fifth example 260 corresponds to the third example 240 of FIG. 2C and further includes the heading of the status 239. The first entry 221 of the fifth example 260 includes Active for a field of the status 239 of the first entry 221, and the second entry 242 includes Inactive for a field of the status 239 of the second entry 242. It is noted that the respective value of the status 239 of the first entry 221 and the second entry 242 in the embodiment of the example of the fifth example 260 is for illustrative purposes, and that each respective value may be active or inactive.

As compared to the third example 240 of FIG. 2C, the fifth example 260 further includes a third entry 263. The third entry 263 includes a third object class for a field of the object class 207, no condition (None) for a field of the condition 210, and Active for a field of the status 239. The third object class (of the third entry 263) may be the same object class or a different object class as the first object class (of the first entry 221) or the second object class (of the second entry 242). Although the condition 210 of the third entry 263 is indicated as no condition (None), in other embodiments, the third entry 263 may include the first condition (Condition 1), the second condition (Condition 2), or a third condition (Condition 3) for a field of the condition 210 of the third entry 263. The third condition (Condition 3) may be different from each of the first condition (Condition 1) and the second condition (Condition 2). It is noted that although the third entry 263 is Active for a field of the status 239, in other embodiments, the third entry 263 may be Inactive for a field of the status 239. To illustrate, the value of the status 239 of the third entry 263 may be changed or modified based on or in response to an input, such as a user input.

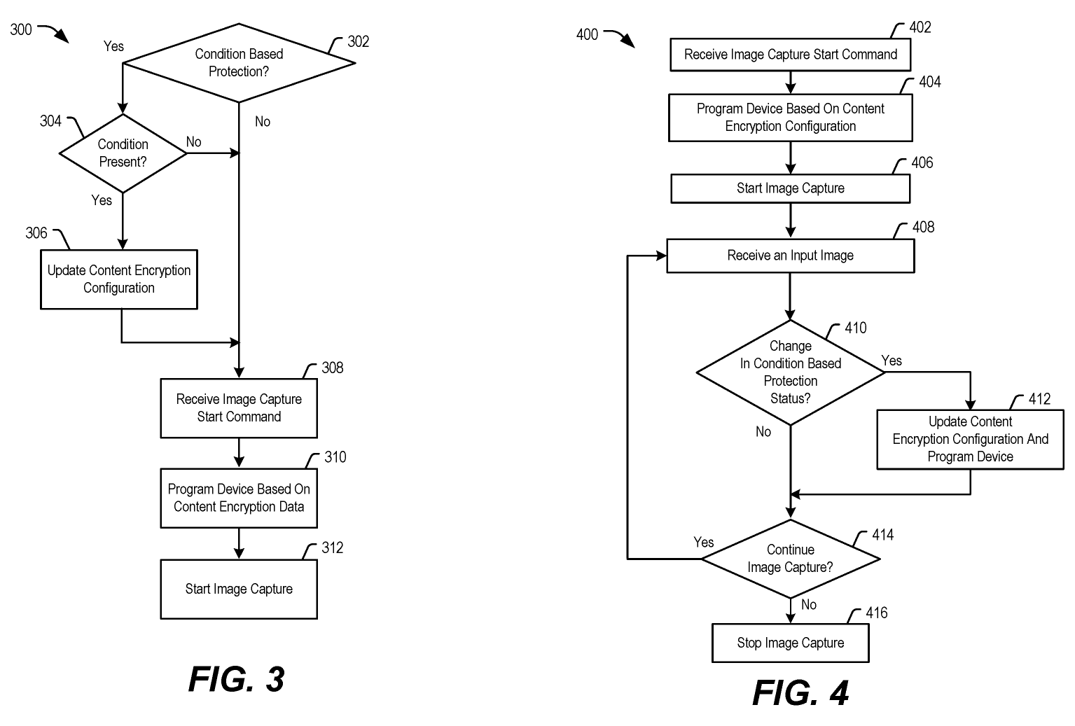

FIG. 3 is a diagram of an example of a method for encryption of media content, in accordance with some aspects of the present disclosure. In a particular aspect, one or more operations of the method 300 are performed by the system 100, the device 102, the processor 108, the protection controller 110, the media generator 120, the encoder 128, or a combination thereof.

In some embodiments, the method 300 includes, at block 302, determining whether a content encryption configuration is associated with content-based protection. For example, the content encryption configuration may include or correspond to the content encryption configuration 130 or one of the entries 221, 242, or 263. The content-based protection may include or correspond to a condition, such as the condition 131. Based on a determination that the content encryption configuration is not associated with content-based protection, the method 300 advances to block 308. Alternatively, based on a determination that the content encryption configuration is associated with content-based protection, the method 300 advanced to block 304.

At block 304, the method 300 includes determining whether the condition is present – e.g., whether or not the condition is satisfied. In some embodiments, a determination of whether or not the condition is present may is based on contextual data, such as the contextual data 132. Based on a determination that the condition is not present, method 300 advances to block 308. Alternatively, based on a determination that the condition is present, the method 300 advances to block 306.

At block 306, the method 300 includes updating the content encryption configuration. For example, updating the content encryption configuration may include updating a status, such as the status 133 or 239, of the content encryption configuration to indicate active.

At block 308, the method 300 includes receiving an image capture start command. For example, the input capture start command may be received via an input device.

At block 310, the method 300 includes programming a device based on the content encryption data. For example, the device may include or correspond to the device 102, the processor 108, the media generator 120, the encoder 128, or a combination thereof. In some embodiments, the device may be programmed by the processor 108 or the protection controller 110.

At block 312, the method 300 includes starting an image capture operation. In some embodiments, the processor 108 or the media generator 120 may start or initiate the image capture operation. The image capture operation may be performed by a camera.

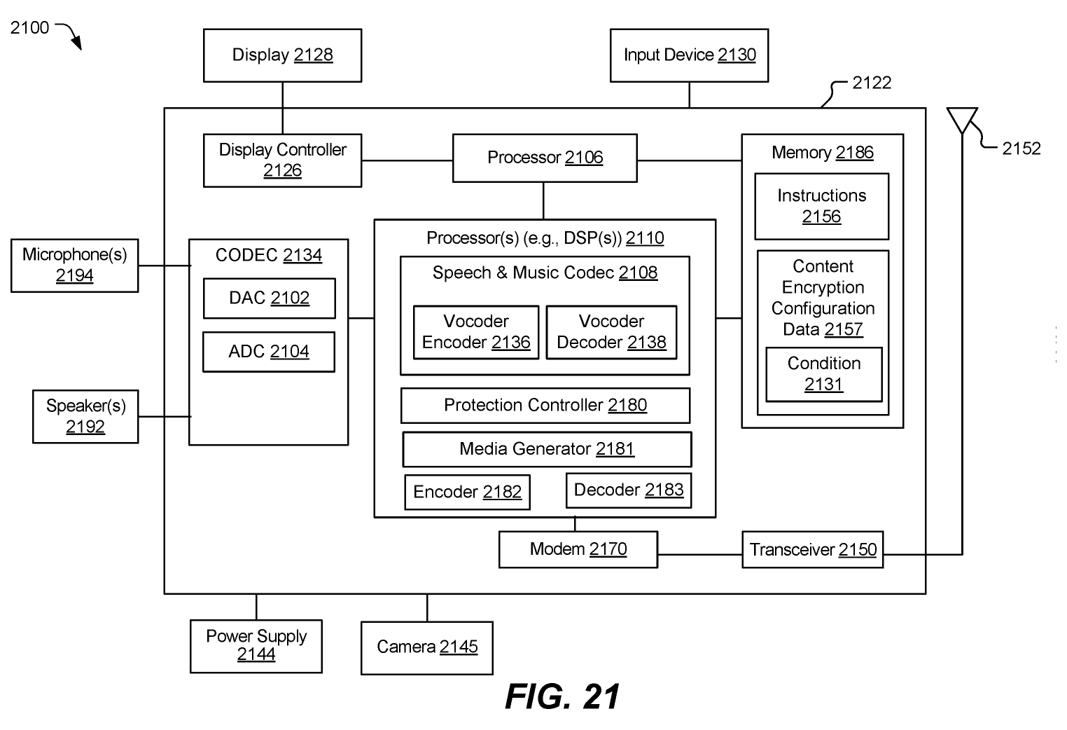

The method 300 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 300 may be performed by a processor that executes instructions, such as described with reference to FIG. 21.

FIG. 4 is a diagram of an example of a method for encryption of media content, in accordance with some aspects of the present disclosure. In a particular aspect, one or more operations of the method 400 are performed by the system 100, the device 102, the processor 108, the protection controller 110, the media generator 120, the encoder 128, or a combination thereof.

In some embodiments, the method 400 includes, at block 402, receiving an image capture start command. For example, the input capture start command may be received via an input device.

At block 404, the method 400 includes programming a device based on a content encryption configuration. The content encryption configuration may include or correspond to the content encryption configuration 130. For example, the device may include or correspond to the device 102, the processor 108, the media generator 120, the encoder 128, or a combination thereof. In some embodiments, the device may be programmed by the processor 108 or the protection controller 110.

At block 406, the method 400 includes starting image capture – e.g., an image capture operation. In some embodiments, the processor 108 or the media generator 120 may start or initiate the image capture operation. The image capture operation may be performed by a camera.

At block 408, the method 400 includes receiving an input image. The input image may include or correspond to the image data 140 or the input image frame 142.

At block 410, the method 400 includes determining whether there is a change in a condition-based protection status. For example, the change in the condition-based protection status may be based on a determination of whether or not the condition is satisfied (e.g., present). The determination of whether or not the condition is satisfied may be based on contextual data, such as the contextual data 132. Based on a determination that there is no change, the method 400 advances to block 414. Alternatively, based on a determination that there is a change, the method 400 advances to block 412.

At block 412, the method 400 includes updating the content encryption configuration and programming the device. For example, updating the content encryption configuration may include updating a status, such as the status 133 or 239, of the content encryption configuration to indicate active or inactive based on the determined change in the condition-based protection status. Additionally, the device may be programmed (e.g., re-programmed or updated) based on the updated content encryption configuration.

At block 414, the method 400 includes determining whether to continue the image capture operation. Based on a determination to continue the image capture operation, the method 400 advances to block 408. Alternatively, based on a determination to not continue the image capture operation, the method 400 advances to block 416.

At block 416, the method 400 includes stopping the image capture operation. In some embodiments, the processor 108 or the media generator 120 may stop or initiate stoppage of the image capture operation. Additionally, or alternatively, a stop image capture command may be received via an input device.

The method 400 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 400 may be performed by a processor that executes instructions, such as described with reference to FIG. 21.

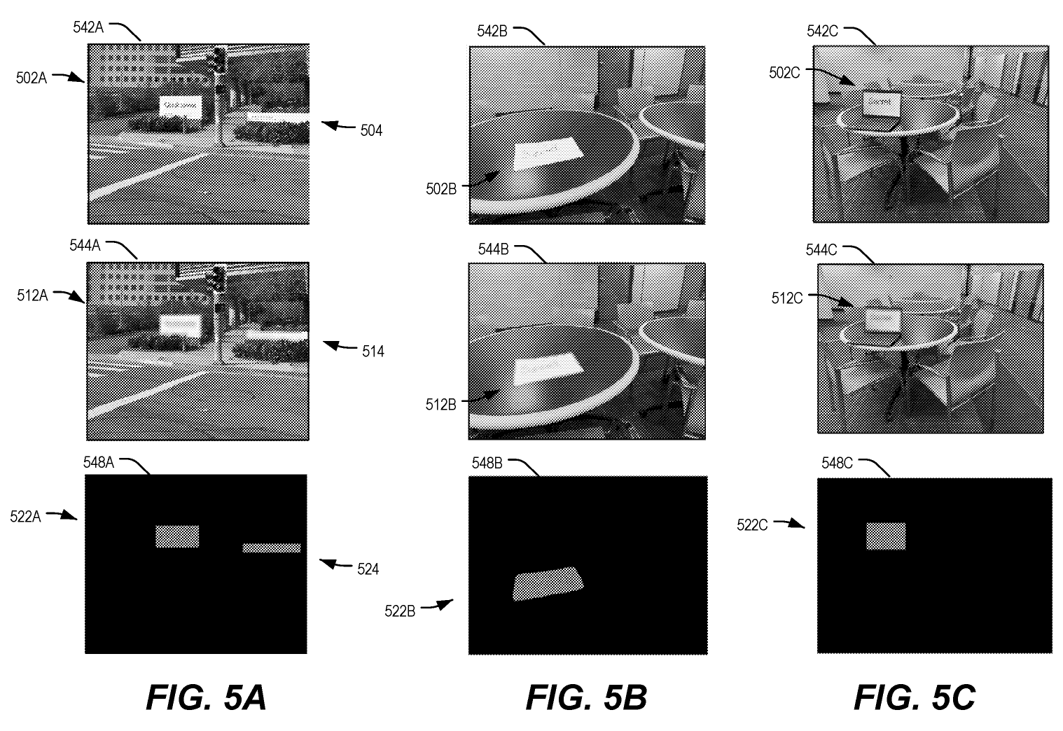

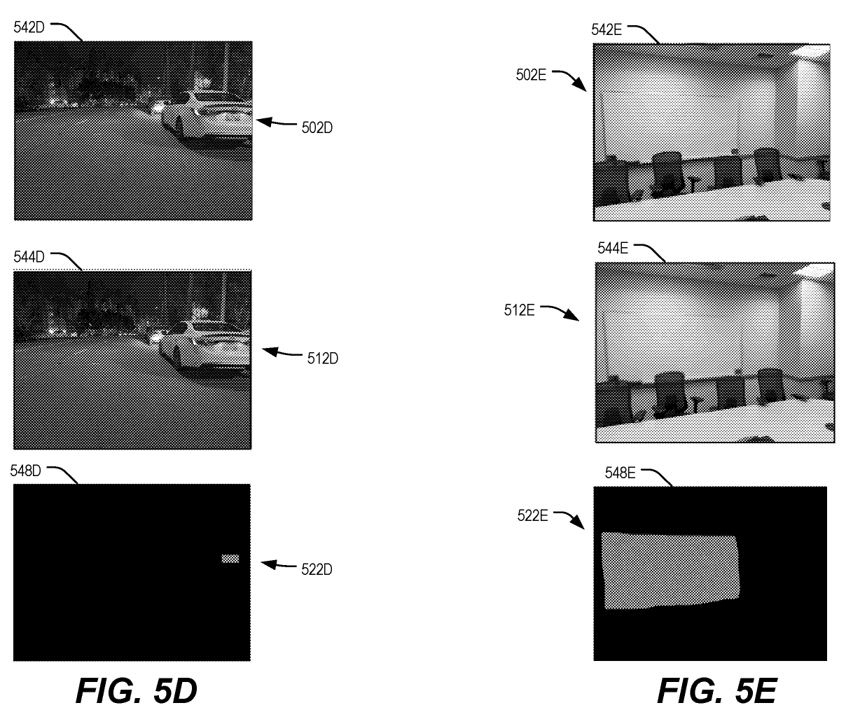

FIGS. 5A-5E are diagrams of examples of image frames to illustrate operations associated with the system of FIG. 1, in accordance with one or more aspects of the present disclosure. For example, the operations may be associated with or correspond to operations of the processor 108 (e.g., the media generator 120) as described with reference to FIG. 1.

The examples of FIGS. 5A-5E each includes an input image frame 542, a masked image frame 544, and an encrypted ROI frame 548 including encrypted content. The input image frame 542, the masked image frame 544, and the encrypted ROI frame 548 (including the encrypted content) may include or correspond to the input image frame 142, the masked image frame 144, and the encrypted ROI content 148, respectively.

The input image frame 542 of the examples of FIGS. 5A-5E includes an image of a scene. Additionally, the input image frame 542 includes one or more instances of an object class, such as the object class 107. For example, the input image frame 542 of the examples of FIG. 5A-5E includes a first instance 502 of a first object class, and the input image frame 542 of FIG. 5A includes a second instance 504 of a second object class. The first object class and the second object class may be the same object class or different object classes.

The masked image frame 544 of the examples of FIGS. 5A-5E includes one or more masked portions and a non-masked portion. The one or more masked portions may include or correspond to the one or more instance of the object class included in the input image frame 542. The masked image frame 544 of the examples of FIGS. 5A-5E includes a first portion 512, and the masked image frame 544 of the example of FIG. 5A includes a second portion 514. The first portion 512 may correspond to the first instance 502 and the second portion 514 may correspond to the second instance 504.

The encrypted ROI frame 548 of the examples of FIGS. 5A-5E includes encrypted content. The encrypted content corresponds to the one or more instances of the object class and/or the one or more masked portions. The encrypted ROI frame 548 of the examples of FIGS. 5A-5E includes first encrypted content 522, and the encrypted ROI frame 548 of the example of FIG. 5A includes second encrypted content 524. The first encrypted content 522 may correspond to the first instance 502 and the second encrypted content 524 may correspond to the second instance 504.

In embodiments in which the first object class associated with the first instance 502 and the second object class associated with the second instance 504 are the same object class, the first encrypted content 522 and the second encrypted content 524 may be generated using the same encryption key (e.g., the key 137). In embodiments in which the first object class associated with the first instance 502 and the second object class associated with the second instance 504 are different object classes, the first encrypted content 522 and the second encrypted content 524 may be generated using the same encryption key (e.g., the key 137) or using different encryption keys. For example, when the first object class and the second object class are different object classes, the first encrypted content 522 may be generated based on a first encryption key and the second encrypted content 524 may be generated based on a second encryption key that is different from the first encryption key. In some embodiments in which the first encrypted content 522 and the second encrypted content 524 are generated using different encryption keys, the first and second encrypted content 522, 524 may be included in the same encrypted ROI frame 548, or, alternatively, the first encrypted content 522 may be included in a first encrypted ROI frame and the second encrypted content 524 may be included in a second encrypted ROI frame.

The examples of FIGS. 5A-5E each depict operations associated with FIG. 1 in which a condition, such as the condition 131 or 210, is satisfied for detection of the object class 107, and the ROI identifier 121 (e.g., an object class detector) identifies an instance of the object class 107 present in the input image frame 542. The ROI masker 122 may generate the masked image frame 544, which is a masked version of the input image frame 542 in which at least one or more detected instances of the object class detected by the ROI identifier 121 are masked. The ROI generator 123 may generate the ROI content that corresponds to or is based on the detected one or more instances detected by the ROI identifier 121. The encryptor 124 may encrypt the ROI content 146 to generate the encrypted ROI frame 548.

Referring to FIG. 5A, the condition includes or is associated with an environment being an outdoor area, a public area, or a combination thereof, and the object class is or includes a sign (e.g., a building sign or a street sign). Accordingly, the first instance 502A is a first sign and the second instance 504 is a second sign. Referring to FIG. 5B, the condition includes or is associated with a physical space associated with an office, availability of a particular wireless network, or a particular geographic location, and the object class is or includes a document. Accordingly, the first instance 502B is a document (e.g., a piece of paper). Referring to FIG. 5C, the condition includes or is associated with a physical space associated with an office, availability of a particular wireless network, or a particular geographic location, and the object class is or includes a monitor (e.g., a screen) or a display device. Accordingly, the first instance 502C is a screen of a laptop computer. Referring to FIG. 5D, the condition includes or is associated with an environment being an outdoor area, a public area, or a combination thereof, and the object class is or includes a license plate. Accordingly, the first instance 502D is a license plate of an automobile. Referring to FIG. 5E, the condition includes or is associated with a physical space associated with an office, availability of a particular wireless network, or a particular geographic location, and the object class includes writing or text on a whiteboard. Accordingly, the first instance 502C is written material on a whiteboard.

FIG. 6A is a diagram of examples of the encoded output data 162 to illustrate operations associated with the system of FIG. 1, in accordance with one or more aspects of the present disclosure. As described above with reference to FIG. 1, the encoded output data 162 may be generated by the encoder 128. For example, the encoder 128 may generate the encoded output data 162 based on the image data 140, the input image frame 142, the masked image frame 144, the encrypted ROI content 148, the output data 160, an ROI segmentation frame (as described further herein at least with reference to FIG. 7A), one or more encoder parameters (e.g., one or more encoding parameters), or a combination thereof.

Each of the examples of the encoded output data 162 of FIG. 6A includes the content protection data 164 and encoded data 610. The content protection data 164 may be included in a header of the encoded output data 162, metadata of the encoded output data 162, or a combination thereof. The content protection data 164 of each of the examples of FIG. 6A includes at least an indicator 607.

The encoded data 610 of each of the examples of FIG. 6A may include or correspond to the masked image frame 144, the encrypted ROI content 148, the output data 160, or a combination thereof. In some embodiments, the encoded data 610 includes an encoded version of the output data 160 encoded by the encoder 128. In some embodiments, the encoded data 610 includes an encoded version of the output data 160 encoded by the encoder 128. In the illustrated embodiment, the encoded data 610 includes an encoded masked image frame 614 and encoded encrypted ROI content 618. The encoded masked image frame 614 may include or correspond to an encoded version of the masked image frame 144 encoded by the encoder 128. The encoded encrypted ROI content 618 may include or correspond to an encoded version of the encrypted ROI content 148 encoded by the encoder 128.

A first example of the encoded output data 162 is designated 600. The encoded output data 162 of the first example 600 includes the indicator 607. The indicator 607 may be associated with the encoded encrypted ROI content 618 and/or may indicate that the encoded data 610 includes or is associated with the encoded encrypted ROI content 618. Additionally, or alternatively, the indicator 607 may include one or more indicators as described further herein with reference to a third example 660 of FIG. 6A.

A second example of the encoded output data 162 is designated 630. The encoded output data 162 of the second example 630, optionally (as indicated by dashed lines), includes position data 652 or an encoded segmentation frame 655 (e.g., segmentation data). For example, the encoded output data 162 includes one of the position data 652 or an encoded segmentation frame 655. Each of the position data 652 and the encoded segmentation frame 655 may enable decrypted ROI content (based on the encoded encrypted ROI content 618) to be combined with a decoded masked image frame (based on the encoded masked image frame 614). For example, the position data 652 may indicate a position (e.g., a pixel location) associated with the decoded masked image frame (based on the encoded masked image frame 614) where the decrypted ROI content (based on the encoded encrypted ROI content 618) is to be positioned.

The encoded segmentation frame 655 may include or correspond to a segmentation frame encoded by the encoder 128. The segmentation frame may include a segmented version of the input image frame 142 that is segmented based on or in association with a detected object class included in the input image frame 142. For example, the segmentation frame 655 may include or correspond to an ROI segmentation frame 755 as described with reference to FIG. 7A. The encoded segmentation frame 655 may be decoded to obtain the segmentation frame which may be used to combine decrypted ROI content (based on the encoded encrypted ROI content 618) with a decoded masked image frame (based on the encoded masked image frame 614).

The third example of the encoded output data 162 is designated 660. The indicator 607 of the third example 660 includes a condition indicator 671, a non-display indicator 673, an object class indicator 675, an encryption indicator 677, an identity indicator 679, and an encrypted key 681. The condition indicator 671 may indicate a condition, such as the condition 131 or 210, associated with the encoded encrypted ROI content 618 (e.g., the encrypted ROI content 148).

The non-display indicator 673 may indicate (for a decoder) to decode particular data (e.g., a particular frame), but not display the decoded data. For example, the non-display indicator 673 may include a non-display flag or a no display message (e.g., a no display SEI message). The non-display indicator 673 may indicate or correspond to the encrypted ROI content 148 (e.g., a frame that includes the encrypted ROI content 148), a segmentation frame, the encoded encrypted ROI content 618, or the encoded segmentation frame 655.

The object class indicator 675 may be associated with an object class (e.g., the object class 107) detected in the input image frame 142 and for which the encrypted ROI content 148 was generated (and thereby the encoded encrypted ROI content 618). Additionally, or alternatively, the object class indicator 675 may indicate one or more object classes, a number of detected objects, a number object classes (detected in the input image frame 142), or a combination thereof.

The encryption indicator 677 may indicate that the encoded output data 162 includes or indicates the encrypted ROI content 148 (e.g., encrypted media data). In an illustrative example, the encryption indicator 677 includes or corresponds to a flag that indicates the presence of encrypted data in the encoded output data 162. Additionally, or alternatively, the encryption indicator 677 may indicate one or more encryption parameters. The one or more encryption parameters may include or indicate an encryption type, a maximum block size, an alphabet size, one or more formatting details, a number of object classes, or a combination thereof.

The identity indicator 679 may include or indicate a device ID of a device (e.g., that generated the encoded output data 162), a user ID of a user of the device, or a combination thereof. For example, the device may include or correspond to the device 102.

The encrypted key 681 may include or correspond to the key 137 used to generate the encrypted ROI content 148. For example, the encrypted key 681 may include or indicate the key 137, an encrypted version of the key 137, a public key used to encrypt the key 137 to generate the encrypted version of the key 137, or a combination thereof.

Although each of the examples of FIG. 6A is described as including the indicator 607, one or more of the examples of FIG. 6A may not include the indicator 607. Additionally, or alternatively, although each of the examples of FIG. 6A is described as including the encoded masked image frame 614 and the encoded encrypted ROI content 618, in other examples, the encoded output data 162 may not include one of the encoded masked image frame 614 or the encoded encrypted ROI content 618. For example, the encoded output data 162 may not include the encoded encrypted ROI content 618.

FIG. 6B is a diagram of an example of a bitstream 699 of encoded output data to illustrate operations associated with the system of FIG. 1, in accordance with one or more aspects of the present disclosure. In an illustrative example, the bitstream 699 corresponds to the encoded output data 162.

The bitstream 699 includes sequence data 670 and a sequence of encoded frames that includes data corresponding to the frames. The sequence data 670 includes encryption parameters 672. The encryption parameters 672 can include, for one or more encryption algorithms used to encrypt data in the sequence, data identifying the particular encryption algorithm, a number of parameters for the particular algorithm, an encryption mode, a total parameter size, values of the parameters for the particular algorithm, or a combination thereof. Examples of possible algorithm parameters include alphabet size, max block size, input data bit-width, public key certificate (e.g., digital certificate or identity certificate), certificate authority, digital signature, one or more other parameters, or a combination thereof. Examples of encryption algorithms include FF1: Format-preserving Feistel-based Encryption Mode (ANSI X9 as X9.119 and X9.124); FF3-1: DRAFT SP 800-38G Rev 2; and FF2: The FFX Mode of Operation for Preserving Encryption, as illustrative, non-limiting examples.

The bitstream 699 also includes an encoded masked image frame 674 and an encoded encrypted ROI frame 692 associated with the encoded masked image frame 674. The encoded masked image frame 674 includes a header 676 and encoded pixel data 680. The header 676 includes metadata associated with a frame of the image data 140 (e.g., the input image frame 142), including a display order frame ID 678, such as a display order frame ID that indicates a display order of the encoded masked image frame 674 in the sequence.

The encoded encrypted ROI frame 692 includes a header 694 and encoded encrypted pixel data 698. The header 694 includes metadata for an encrypted ROI frame (e.g., the encrypted ROI content 148) corresponding to the encoded masked image frame 674. As illustrated, the header 694 includes a no display SEI 686 that indicates that the encoded encrypted ROI frame 692 is not to be displayed, the frame ID 687 that indicates or corresponds to the display order frame ID 678 to associate the encoded encrypted ROI frame 692 with the encoded masked image frame 674, and the indicator 607. In some embodiments, the header 694 also may include encryption parameters associated with the encrypted ROI(s) in the encoded encrypted ROI frame 692.

Although the bitstream 699 is described as including both the encoded masked image frame 674 and the encoded encrypted ROI frame 692, in other embodiments, the bitstream 699 may include one of the encoded masked image frame 674 or the encoded encrypted ROI frame 692 and not the other. For example, the bitstream 699 may include the encoded masked image frame 674 and not the encoded encrypted ROI frame 692. Alternatively, the bitstream 699 may include the encoded encrypted ROI frame 692 and not the encoded masked image frame 674.

Although the encoded output data 162 of FIG. 6A and the bitstream 699 of FIG. 6B are described above in the context of a bitstream-based arrangement, in some embodiments the components of the encoded output data 162 — including, for example, the encoded masked image frame 614 (e.g., the encoded masked image frame 674), the encoded encrypted ROI content 618 (e.g., the encoded encrypted ROI frame 692), the position data 652, the encoded segmentation frame 655, the indicator 607, and the content protection data 164 — are instead organized within a media container as described herein with reference to FIG. 1. For example, the encoded masked image frame 614 may be included in a first track of the media container, the encoded encrypted ROI content 618 may be included in a second track of the media container, and the position data 652, the encoded segmentation frame 655, the indicator 607, and the content protection data 164 may be included in a metadata field, a supplemental track, an embedded data field, or a combination thereof, of the media container.

In some such embodiments, frame association data analogous to the display order frame ID 678 and the frame ID 687 (which, in the bitstream 699, are included in the headers 676 and 694, respectively) may be carried as container-level metadata to associate frames within the media container. Additionally, or alternatively, an indication that a frame or track of the media container is not to be displayed by a standard media player (analogous to the no-display SEI 686 in the bitstream 699) may be included as container-level metadata associated with the encoded encrypted ROI content 618, the encoded segmentation frame 655, or both.

FIG. 7A is a diagram of an illustrative example of the processor 108 of the system 100 of FIG. 1, in accordance with one or more aspects of the present disclosure. The processor 108 of FIG. 7A is configured to generate an ROI segmentation frame 755, as described herein. The ROI segmentation frame 755 may be associated with or correspond to the encoded segmentation frame 655.

The processor 108 includes the media generator 120 and the encoder 128. It is noted that the processor 108 may also include additional components or circuity not shown in FIG. 7A. The media generator 120 includes the ROI identifier 121, the ROI masker 122, the ROI generator 123, the encryptor 124, an encrypted ROI positioner 734, and the output data generator 127. The ROI identifier 121 includes an ROI detector 710 and an ROI segmentor 712.

The ROI detector 710 is configured to detect an instance of the object class 107 included in the input image frame 142, and identify an ROI associated with the detected instance of the object class 107. The ROI identifier 121 may receive the content protection indicator 135 that includes or indicates the object class 107. In some examples, the content protection indicator 135 includes or indicates a model to be used by the ROI identifier 121 (e.g., the ROI detector 710) to detect the object class 107 included in the input image frame 142.

The ROI segmentor 712 is configured to, based on the ROI identified by the ROI detector 710, generate the ROI segmentation frame 755. For example, the ROI segmentation frame 755 may indicate the ROI (identified by the ROI detector 710) in a frame.

The ROI masker 122 is configured to receive a mask indicator 704. In some embodiments, the mask indicator 704 is received from the protection controller 110. For example, the content protection indicator 135 may include or indicate the mask indicator 704. The mask indicator 704 may include or indicate a mask technique or a mask type to be used by the ROI masker 122. The ROI masker 122 may generate the masked image frame 144 based on the mask indicator 704, the input image frame 142, and the ROI segmentation frame 755. For example, the ROI masker 122 may apply a mask (based on the mask indicator 704) to the input image frame 142 at a location/position based on the ROI segmentation frame 755 to generate the masked image frame 144.

The ROI generator 123 includes an ROI extractor 720 and an ROI vectorizer 722. The ROI extractor 720 is configured to extract an ROI from the input image frame 142. The extracted ROI may be a two-dimensional (2D) data structure, such as a 2D array that is at least partially populated with pixel values of pixels that are indicated, by use of the ROI segmentation frame 755, to be within the ROI. In a particular embodiment, the ROI extractor 720 applies the ROI segmentation frame 755 as a segmentation mask to the input image frame 142 to extract the ROI.

The ROI vectorizer 722 is configured to generate one or more ROI vectors 724 based on the extracted ROI. The ROI vector 724 may be one-dimensional (1D). In some embodiments, to generate the ROI vector 724, the ROI vectorizer 722 is configured to perform a raster scan on the extracted ROI. For pixel formats with no chroma-subsampling, such as YUV444 or RGB, each channel may be added one after the other to generate the ROI vector 724. Alternatively, the ROI vectorizer 722 may generate the ROI vector 724 one channel at a time. For other pixel formats with chroma-subsampling, such as YUV420, the segmentation mask may be downscaled using a chroma sub-sampling ratio and the downscaled data may be vectorized accordingly. It is noted that the ROI vectorizer 722 may generate a respective ROI vector 724 for each object of the object class 107 detected in the input image frame 142.

The encryptor 124 is configured to receive the ROI vector 724 and encrypt the ROI vector 724 to generate encrypted ROI content 732. For example, the encryptor 124 may receive the ROI vector 724 from the ROI generator 123 and encode, based on the key 137, the ROI vector 724. In some embodiments, the encryptor 124 uses a format preserving encryption (input and output have the same size) to generate the encrypted ROI content 732 based on the ROI of the ROI vector 724.

The encrypted ROI positioner 734 is configured to receive the encrypted ROI content 732 and generate the encrypted ROI frame 736. For example, the encrypted ROI positioner 734 may receive the ROI segmentation frame 755 and may position the encrypted ROI content 732 in the ROI segmentation frame 755 to generate the encrypted ROI frame 736. To illustrate, the encrypted ROI positioner 734 may position the encrypted ROI content 732 in the ROI segmentation frame 755 at a location/position that is associated with the ROI identified by the ROI identifier 121. In some embodiments, the encrypted ROI positioner 734 receives the encrypted ROI content 732 (e.g., a 1D vector) and converts the 1D vector back into a 2D data structure. The encrypted ROI positioner 734 may include the encrypted ROI using the same exact location as the original data using the initial segmentation.

The output data generator 127 is configured to generate the output data 160 based on the masked image frame 144, the ROI segmentation frame 755, the encrypted ROI frame 736, one or more encoder parameters, or a combination thereof. For example, the output data generator 127 may combine the masked image frame 144, the ROI segmentation frame 755, the encrypted ROI frame 736, one or more encoder parameters, or a combination thereof, to generate the output data 160. In some embodiments, to generate the output data 160, the output data generator 127 is configured to concatenate the masked image frame 144, the ROI segmentation frame 755, and the encrypted ROI frame 736 to generate the output data 160.

The encoder 128 is configured to receive the output data 160 and generate encoded output data 162. In some embodiments, the encoder 128 may encode the output data 160 based on the content protection indicator 135, one or more encoder parameters received from the protection controller 110 and/or the media generator 120, or a combination thereof. Additionally, or alternatively, the encoder 128 may include additional data to facilitate decode processing of the encoded output data 162 by a decoder.

FIG. 7B is a diagram of an example of a bitstream 799 of encoded output data to illustrate operations associated with the system of FIG. 7A, in accordance with one or more aspects of the present disclosure. The bitstream 799 may include or correspond to the bitstream 699.

The bitstream 799 also includes the encoded masked image frame 674, an encoded segmentation frame 782 associated with the encoded masked image frame 674, and the encoded encrypted ROI frame 692 associated with the encoded masked image frame 674. The encoded segmentation frame 782 includes a header 694 and encoded pixel data 790. The header 784 includes metadata for a ROI segmentation frame (e.g., the ROI segmentation frame 755 of FIG. 7A) corresponding to the encoded masked image frame 674. As illustrated, the header 784 includes the no display SEI 686 that indicates that the frame is not to be displayed, and includes the frame ID 687 that indicates or corresponds to the display order frame ID 678 to associate the encoded segmentation frame 782 with the encoded masked image frame 674. In some embodiments, the header 784 may include an ROI segmentation frame flag that identifies the frame as an encoded segmentation frame. Additionally, or alternatively, the header 784 may include ROI ID data associated with ROIs in the frame, such as a number of ROIs in the frame and identification of each of the ROIs in the frame.

Although the bitstream 799 is described as including each of the encoded masked image frame 674, encoded segmentation frame 782, and the encoded encrypted ROI frame 692, in other embodiments, the bitstream 699 may not include one of the encoded masked image frame 674, the encoded segmentation frame 782, or the encoded encrypted ROI frame 692. For example, the bitstream 799 may include the encoded masked image frame 674 and the encoded segmentation frame 782. Alternatively, the bitstream 799 may include the encoded segmentation frame 782 and the encoded encrypted ROI frame 692.

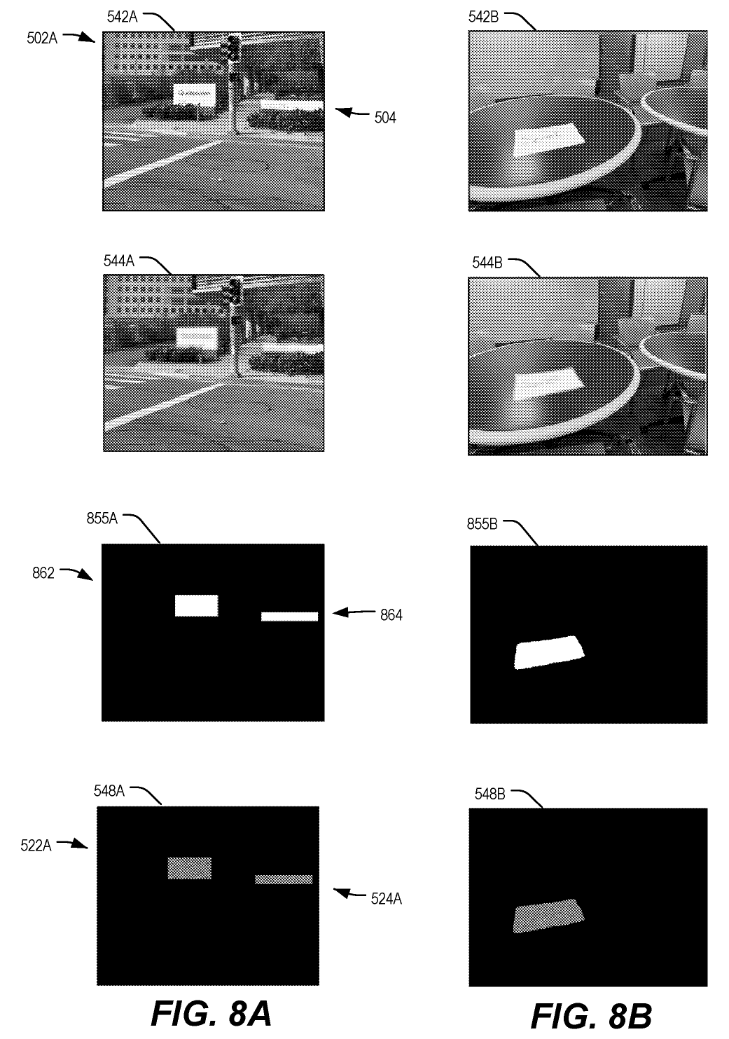

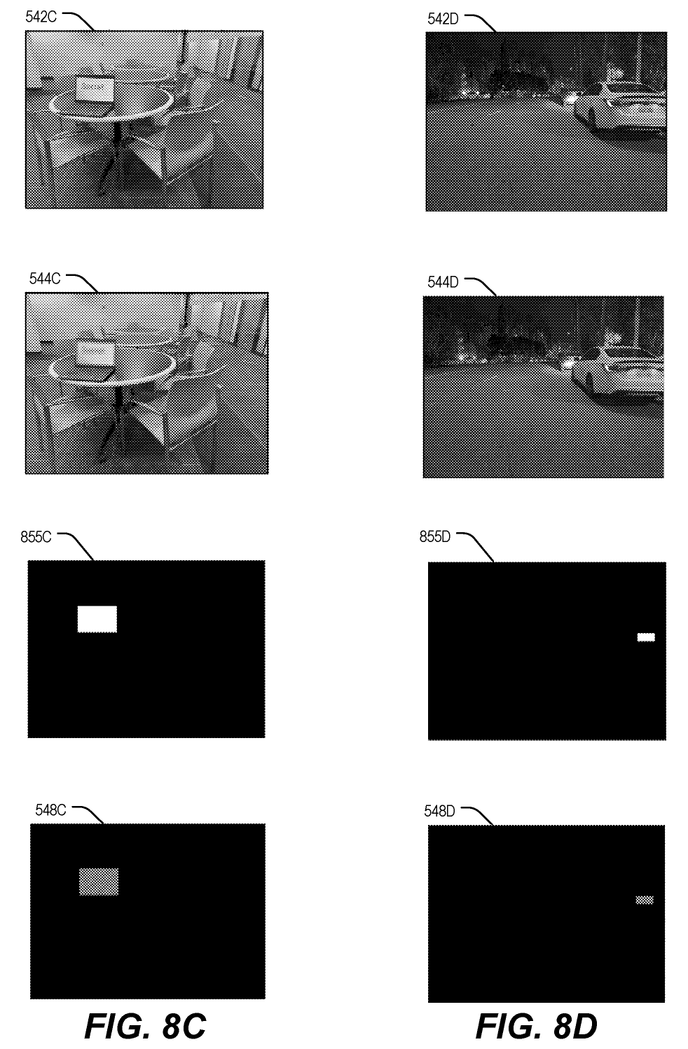

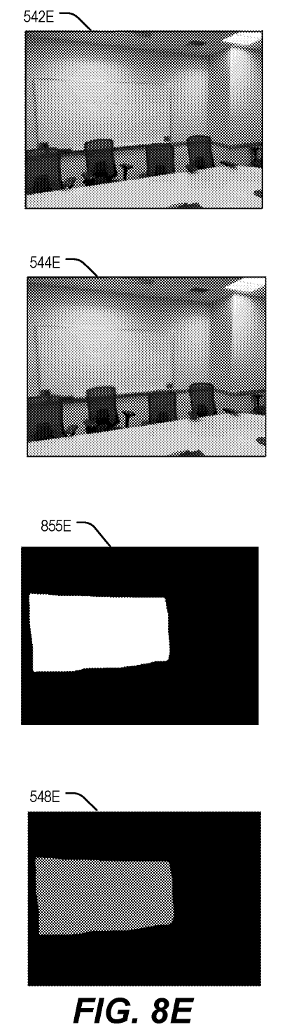

FIGS. 8A, 8B, 8C, 8D, and 8E, are diagrams of examples of image frames to illustrate operations associated with the system of FIG. 1, in accordance with one or more aspects of the present disclosure. For example, the operations may be associated with or correspond to operations of the processor 108 (e.g., the media generator 120) as described with reference to FIGS. 1 and 7A . It is noted that the examples of FIGS. 8A-8E include or correspond to the examples of FIGS. 5A-5E, respectively.

The examples of each of FIGS. 8A-8E includes the input image frame 542, the masked image frame 544, a segmentation frame 855, and the frame including encrypted content (e.g., the encrypted ROI frame 548). The input image frame 542 and the masked image frame 544 may include or correspond to the input image frame 142 and the masked image frame 144, respectively. The encrypted ROI frame 548 (including the encrypted content) may include or correspond to the encrypted ROI content 148 or the encrypted ROI frame 736. The segmentation frame 855 may include or correspond to the encoded segmentation frame 655 or the ROI segmentation frame 755. For purposes of illustration, the segmentation frame 855 includes pixels having two values: white (e.g., 1) for pixels in an identified ROI, and black (e.g., 0) for pixels not in an identified ROI. With reference to FIG. 8A, the segmentation frame 855A indicates a first ROI 862 corresponding to the first instance 502A (e.g., a first sign) and a second ROI 864 corresponding to the second instance 504 (e.g., a second sign) of the input image frame 242A.

The examples of FIGS. 8A-8E are described herein with reference to operations associated with FIG. 7A in which the content protection indicator 135 indicates the object class 107. For example, the ROI identifier 121 (e.g., the ROI detector 710) may identify an instance of the object class 107 indicated by the content protection indicator 135 as present in the input image frame 542. The ROI identifier 121 (e.g., the ROI segmentor 712) may generate the ROI segmentation frame 755 (e.g., the segmentation frame 855) based on the instance (e.g., the ROI) of the object class detected by the ROI detector 710.

The ROI masker 122 may generate, based on the input image frame 142 and the ROI segmentation frame 755, the masked image frame 544 which is a masked version of the input image frame 542 in which at least one or more objects (e.g., the instances 502, 504) detected by the ROI identifier 121 are masked. The ROI generator 123 may generate, based on the input image frame 142 and the ROI segmentation frame 755, the ROI vector 724 that is associated with content that corresponds to or is based on the detected one or more objects detected by the ROI identifier 121. The encryptor 124 may encrypt the ROI content 146 to generate the encrypted ROI content 732. The encrypted ROI positioner 734 may generate the encrypted ROI frame 548 based on the encrypted ROI content 732 and the ROI segmentation frame 755.

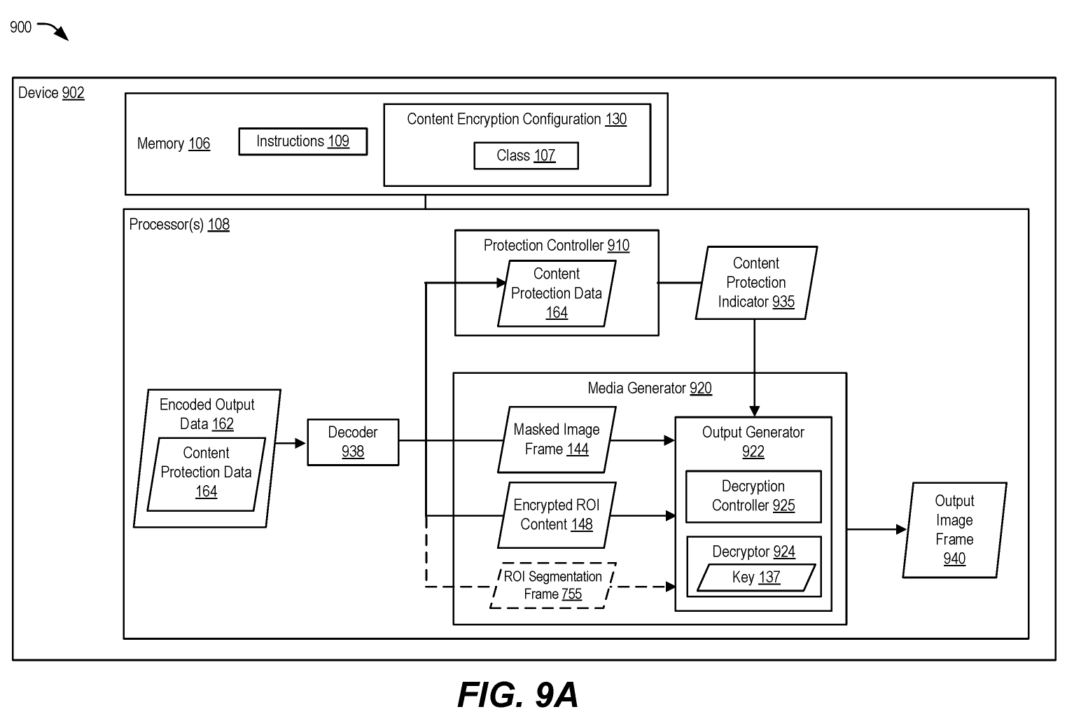

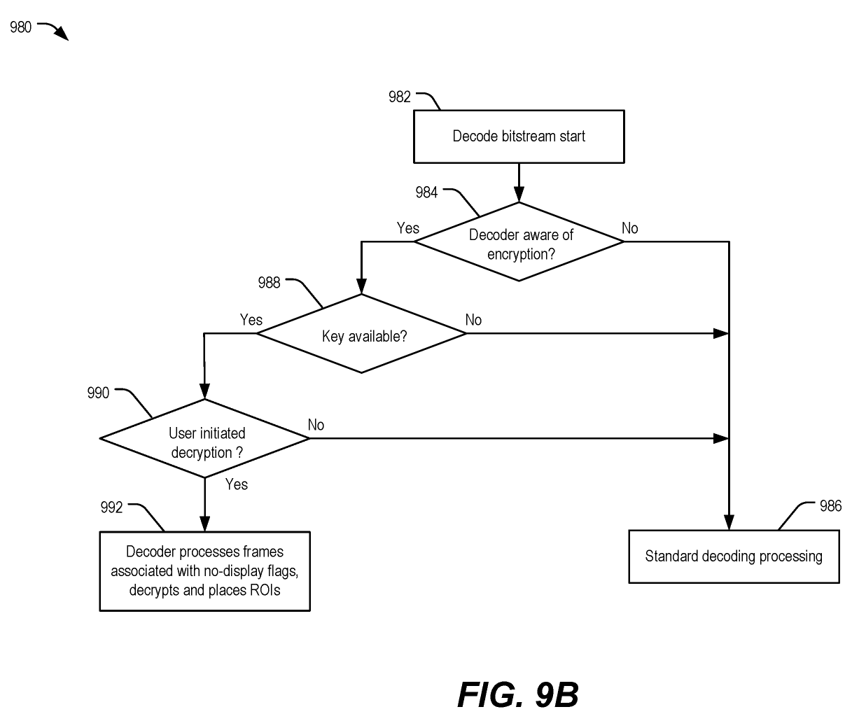

FIG. 9A is a block diagram of an example of a system 900 to decode media content, in accordance with one or more aspects of the present disclosure. The system 900 includes a device 902 that is configured to or is operable to identify encrypted media content and decrypt the encrypted media content. The device 902 may include or correspond to the device 102.

The device 902 includes, or is coupled to, the memory 106 and the processor 108. The memory 106 is configured to store the instructions 109 and the content encryption configuration 130. The content encryption configuration 130 may be associated with or indicate content (e.g., sensitive content) to be protected. The content encryption configuration 130 includes the object class 107. In some embodiments, the content encryption configuration 130 also includes a key, such as an encryption/decryption key (e.g., the key 137), that is associated with or corresponds to the object class 107. The key may be configured to decrypt at least a portion of media content that includes or is associated with an instance of the object class 107.

In some embodiments, the device 902 includes an interface configured to receive the encoded output data 162. The interface may include or correspond to a modem, a network interface, a bus interface, a wireless transceiver, or a combination thereof. In some examples, the interface includes a wired interface, such as a bus interface, a wired network interface, a cable interface, or a combination thereof. In some other examples, the interface includes a wireless interface, such as a wireless transceiver, a cellular modem, a Wi-Fi interface, a Bluetooth interface, or a combination thereof. In some embodiments, the interface is configured to provide the encoded output data 162 to the processor 108. In some examples, the processor 108 (e.g., the media generator 920) is configured to generate the output image frame 940 based on the encoded output data 162, where the output image frame 940 includes the masked image frame 144 or a modified version of the masked image frame 144 that includes decrypted content based on the encrypted ROI content 148.

In some examples, the memory 106 stores other information or data, such as media content. The media content can include or indicate audio content, video content, or a combination thereof. In some examples, the stored media content includes at least an encrypted portion.

The processor 108 includes a protection controller 910, a media generator 920, and a decoder 938. The protection controller 910 and the media generator 920 may include or correspond to the protection controller 110 and the media generator 120, respectively. Each of the protection controller 910, the media generator 920, and the decoder 938, or a portion thereof, may be implemented by the processor 108 executing instructions (e.g., software), dedicated hardware (e.g., circuitry), or a combination thereof. It is noted that in some embodiments, two or more of the protection controller 910, the media generator 920, or the decoder 938 may be combined. For example, the media generator 920 may include the protection controller 910, the decoder 938, or both.

The decoder 938 is configured to receive the encoded output data 162 and decode the encoded output data 162 to obtain the output data 160 including the content protection data 164, and decode the output data 160 to obtain the content protection data 164, the masked image frame 144, and the encrypted ROI content 148. In some embodiments, the decoder 938 may, optionally (as indicated by the dashed lines), decode the encoded output data 162 to obtain the ROI segmentation frame 755. The decoder 938 may also decode the content protection data 164 to identify or determine one or more indicators, data, or a combination thereof, included in or indicated by the content protection data 164. For example, the content protection data 164 may include or indicate an object class indicator (that indicates the object class, a number of object classes, or a combination thereof), a device ID, a user ID of a user of the device, an encryption type indicator, one or more encryption parameters, or a combination thereof.

The protection controller 910 is configured to receive at least a portion of the content protection data 164. The protection controller 910 may determine, based on the content protection data 164, a content protection indicator 935. The content protection indicator 935 may include or indicate the key 137, one or more encryption/decryption parameters, the object class 107, or a combination thereof. For example, the protection controller 910 may determine the object class 107 based on an object class indicator included in or indicated by the content protection data 164. As another example, the protection controller 910 may determine the encryption/decryption parameters based on an encryption indicator, an identity indicator, an object class indicator, or a combination thereof, included in or indicated by the content protection data 164. In some embodiments, the content protection indicator 935 may indicate content encryption configuration 130 (e.g., an encryption requirement) that includes the object class 107, a key (e.g., the key 137, a public key, or a private key), or a combination thereof, to be applied by the media generator 920 (e.g., the output generator 922) to identify or detect, and decrypt the encrypted ROI content 148. In some embodiments, the content protection indicator 935 may indicate a list of object classes 107 and, for each object class, a respective key associated with the object class to enable decryption of one or more encrypted instances of the object class. The protection controller 910 may provide the content protection indicator 935 to the media generator 920 (e.g., the output generator 922).

In some embodiments, the protection controller 910 is configured to determine whether or not the device 902 or a user of the device 902 is authorized or unauthorized to decrypt the encrypted ROI content 148. For example, the protection controller 910 may determine whether or not the device 902 or the user of the device 902 is authorized or unauthorized based on the content protection data 164, the content encryption configuration 130, a key (e.g., a private key or the key 137), or a combination thereof. In some such embodiments, the content protection indicator 935 may indicate whether the device 902 or a user of the device 902 is authorized or unauthorized, and/or a manner in which the output generator 922 is to provide the output image frame 940.

The media generator 920 includes the output generator 922. The output generator 922 includes a decryption controller 925 and a decryptor 924. The media generator 920 (e.g., the output generator 922) is configured to receive the masked image frame 144, the encrypted ROI content 148, and the content protection indicator 935. The media generator 920 (e.g., the output generator 922) may also obtain the key 137. In some embodiments in which the encoded output data 162 includes an encoded version of the ROI segmentation frame 755, the media generator 920 (e.g., the output generator 922) is also configured to receive the ROI segmentation frame 755 from the decoder 938.

The output generator 922 is configured to generate the output image frame 940 based on the masked image frame 144, or based on a combination of the masked image frame 144 and the encrypted ROI content 148 and/or the ROI segmentation frame 755. For example, the output generator 922 may selectively generate the output image frame 940 based on whether the device 902 and/or a user associated with the device 902 is authorized to decrypt the encrypted ROI content 148. To illustrate, in some embodiments, if the device 902 and/or the user of the device 902 is unauthorized, the output generator 922 may output the masked image frame 144 as the output image frame 940. In other embodiments, if the device 902 and/or the user of the device 902 is authorized, the output generator 922 may decrypt the encrypted ROI content 148 using the key 137 to obtain (e.g., generate) decrypted ROI content (e.g., the ROI content 146) that is combined with the masked image frame 144 to generate the output image frame 940. In some other embodiments, if the device 902 and/or the user of the device 902 is authorized and the ROI segmentation frame 755 is obtained by the media generator 920 (e.g., the output generator 922), the output generator 922 may decrypt the encrypted ROI content 148 using the key 137 to obtain (e.g., generate) decrypted ROI content (e.g., the ROI content 146) that is combined, based on the ROI segmentation frame 755, with the masked image frame 144 to generate the output image frame 940.

The decryption controller 925 may be configured to selectively configure the output generator 922 (e.g., the decryptor 924) to output the output image frame 940. For example, based on a determination or an indication that the device 902 and/or the user of the device 902 is unauthorized, the decryption controller 925 may configure the output generator 922 to output the masked image frame 144 as the output image frame 940. To illustrate, the decryption controller 925 may pass through the masked image frame 144 as the output image frame 940 and does not display or decrypt the encrypted ROI content 148. As another example, based on a determination or an indication that the device 902 and/or the user of the device 902 is authorized, the decryption controller 925 may configure the output generator 922 to output the output image frame 940 that includes a decrypted version (e.g., the ROI content 146) of the encrypted ROI content 148. In some such examples, the output generator 922 may combine the ROI content 146 with the masked image frame 144 to generate the output image frame 940. It is noted that although the decryption controller 925 is described as being included in the media generator 920 (e.g., the output generator 922), in other embodiments, the decryption controller 925 may be included in the protection controller 910.

The decryptor 924 is configured to selectively decrypt or attempt to decrypt the encrypted ROI content 148 to obtain the ROI content 146. For example, the decryptor 924 may selectively decrypt or attempt to decrypt the encrypted ROI content 148 based on the key 137, an indicator or control signal from the decryption controller 925, the content protection indicator 935, or a combination thereof.

During operation of the system 900, the processor 108 obtains the encoded output data 162. The encoded output data 162 includes the content protection data 164 and encoded data. In some embodiments, the encoded output data 162 is associated with media content, such as image data, audio data, or a combination thereof.

The encoded output data 162 is provided to the decoder 938 which decodes the encoded output data 162. Based on decoding the encoded output data 162, the decoder 938 provides the content protection data 164 to the protection controller 910, and provides the masked image frame 144 and the encrypted ROI content 148 to the media generator 920. In some embodiments, the decoder 938 also provides the ROI segmentation frame 755 to the media generator 920 based on decoding the encoded output data 162.

In some embodiments, the protection controller 910 and/or the decryption controller 925 may determine whether or not the device 902 or the user of the device is authorized or unauthorized to output the output image frame 940 that includes a decrypted version of the encrypted ROI content 148. If the device 902 or the user of the device 902 is unauthorized, the output generator 922 may output the masked image frame 144 as the output image frame 940. Alternatively, if the device 902 or the user of the device 902 is authorized, the decryptor 924 may decrypt, based on the key 137, the encrypted ROI content 148 to obtain the ROI content 146, and the output generator 922 may modify the masked image frame 144 based on (e.g., to include) the ROI content 146 to generate the output image frame 940. In some embodiments, the output image frame 940 includes or corresponds to the input image frame 142, a bitstream, or a combination thereof. Additionally, or alternatively, the output image frame 940 may be stored at the memory 106 or sent to another device for output.

In some embodiments, a device (e.g., the device 902) includes a memory (e.g., the memory 106) and one or more processors (e.g., the processor 108). The memory is configured to store a content encryption configuration (e.g., the content encryption configuration 130) that indicates an object class (e.g., the object class 107). The one or more processors are configured to obtain output media data (e.g., the encoded output data 162). The output media data includes encrypted media data (e.g., the encrypted ROI content 148) including an encrypted portion of media data. The encrypted portion of the media data is associated with an instance of the object class. The one or more processors are further configured to decrypt, based on a key (e.g., the key 137), the encrypted portion of the media data to obtain a portion of the media data.

In some examples, the device 902 corresponds to or is included in one of various types of devices, such that the processor 108 can be integrated in multiple types of devices. In an illustrative example, the processor 108 is integrated in a wearable electronic device as depicted in FIG. 13, a virtual reality, mixed reality, or augmented reality headset as depicted in FIG. 16, a mixed reality or augmented reality glasses device as described with reference to FIG. 17, or another wearable device. In another illustrative example, the processor 108 is integrated in a mobile device (a mobile phone or a tablet computer) as depicted in FIG. 12, a voice-controlled speaker system as depicted in FIG. 14, a camera as depicted in FIG. 15, a vehicle as depicted in FIGS. 18 or 19 , a computer (e.g., a laptop computer) or a server, or another system or device.

As described with reference to FIG. 9A, the present disclosure provides techniques for supporting decoding or decryption of media content. For example, one technical advantage of implementing the device 902 as described above is that privacy control and content management of sensitive content which may be selectively decrypted based on the key 137. To further illustrate the technical advantage, the sensitive content of the media content is masked in the masked image frame 144, which can be displayed or stored by the device 902 based on not having authorization or access to the sensitive content (e.g., the encrypted ROI content 148). In some aspects, device 902 is authorized to access the sensitive content and decrypts the encrypted ROI content 148 to obtain (e.g., recover) the sensitive content. The sensitive content may then be combined with the masked image frame 144 to obtain the output image frame 940 - e.g., to recreate the original media content (e.g., the input image frame 142). In some embodiments, the operations described with reference to the system 900 may be applied to provide automatic sensitive content (partial video) decryption. The partial video decryption can allow for both authorized and non-authorized access of encrypted content using the same encoded output data 162 (e.g., the same encrypted bitstream).

FIG. 9B is a diagram of an example of operations 980 that may be performed at the system 900 of FIG. 9A, such as at the decoder 938, the protection controller 910, the media generator 920, or a combination thereof. The operations 980 include starting a decode process of a bitstream, at block 982. For example, an encoded video bitstream can be received at the decoder 938 as the encoded output data 162, the bitstream 699, or the bitstream 799.

In some embodiments in which the encoded output data 162 includes a media container (e.g., an MPEG-4 (MP4) container, an Audio Video Interleave (AVI) container, an MPEG transport stream container, or another multimedia container format), the decoder 938 is configured to access components of the media container to obtain the encoded masked image frame 614, the encoded encrypted ROI content 618, the content protection data 164, the segmentation data, or a combination thereof. For example, the decoder 938 may access a first track of the media container to obtain the encoded masked image frame 614 and a second track of the media container to obtain the encoded encrypted ROI content 618. Additionally, or alternatively, the decoder 938 may access a metadata field of the media container, a supplemental track of the media container, an embedded data field of the media container, or a combination thereof, to obtain the content protection data 164, the segmentation data, or both.

In a particular example, a decoder that is not configured to process the content protection data 164 may play back the first track of the media container to display the masked version of the input media data (e.g., based on the encoded masked image frame 614), while the decoder 938 (which is configured to process the content protection data 164) may access the second track to obtain the encoded encrypted ROI content 618, decrypt the encrypted ROI content 148 based on the key 137, and provide the decrypted ROI content to the media generator 920 to be combined with the masked image frame 144 to generate the output image frame 940.

At block 984, a determination is made as to whether the decoder that receives the bitstream is “aware of” encryption. As used herein, a decoder is aware of encryption when the decoder is configured to detect that the bitstream includes encrypted content, such as the encoded data 610 (e.g., the encoded encrypted ROI content 618) or an encryption indicator that indicates encrypted content. Additionally, a decoder is not aware of encryption when the decoder is not configured to detect that the bitstream includes encrypted content (e.g., a “legacy” or “standard” decoder that is not configured to detect encrypted content or another indicator).

Based on the decoder not being aware of encryption, standard decoding processing is performed on the bitstream, at block 986. For example, any encrypted content in the bitstream that is associated with a no-display SEI is ignored when generating the decoded output. Thus, when a bitstream includes the masked image frame 144 and the encrypted ROI content 148, the resulting output image frame corresponds to the masked image frame 144, while the encrypted ROI content 148 is unused (e.g., discarded or ignored).

Based on the decoder being aware of encryption, a determination is made as to whether an encrypted key is available, at block 988. Based on no encrypted key being detected, standard decoding processing is performed on the bitstream, at block 986. Alternatively, based on the key (e.g., the key 137) being available, the operations 980 advance to block 990.

At block 902, a determination is made as to whether decryption has been enabled. For example, in some embodiments the device 902 is responsive to a user input (e.g., received via a user interface, or one or more selectable application settings) that indicates whether protected content is to be shown during playout (via decryption and insertion into the respective ROI) or if instead the masked content is to be shown during playout. Based on decryption not being enabled, standard decoding processing is performed on the bitstream, at block 986. Alternatively, when decryption is enabled, frames associated with non-display flags are processed, encrypted content is decrypted based on the key (e.g., the key 137) and placed into respective ROIs for playout, at block 992. For example, the decryptor 924 may decrypt the encrypted ROI content 148 to obtain the ROI content 146. The output generator 922 may modify the masked image frame 144 based on (e.g., to include) the ROI content 146 to generate the output image frame 940.

FIG. 10 is a block diagram of an example of a system 1000 to encrypt and decrypt media content, in accordance with one or more aspects of the present disclosure. The system 1000 includes a device 1002 that is configured to or is operable to encrypt and/or decrypt media content. In some embodiments, the device 1002 includes or corresponds to the device 102 or the device 902.

The device 1002 includes, or is coupled to, the memory 106 (e.g., a memory device), the processor 108, an image sensor 1012, an input device 1014, a display device 1016, a speaker 1017, and a modem 1018. The memory 106 may include one or more memory devices, such as a single memory or multiple different memory devices (of the same type or of different types).

The memory 106 is configured to store the instructions 109 and the content encryption configuration 130. The instructions 109, when executed by the processor 108, cause the processor 108 to perform one or more operations as described herein. The content encryption configuration 130 includes the object class 107, the condition 131, and the status 133. In some examples, the memory 106 stores other information or data, such as media content. The media content can include or indicate audio content, video content, or a combination thereof. In some examples, the stored media content includes at least an encrypted portion.

The processor 108 includes a protection controller 1010, a media generator 1020, an encoder 1028, and a decoder 1038. Each of the protection controller 1010, the media generator 1020, the encoder 1028, and the decoder 1038, or a portion thereof, may be implemented by the processor 108 executing instructions (e.g., software), dedicated hardware (e.g., circuitry), or a combination thereof. The protection controller 1010, the media generator 1020, the encoder 1028, and the decoder 1038 may include or correspond to the protection controller 110 or 910, the media generator 120 or 920, the encoder 128, and the decoder 938, respectively. It is noted that although the device 1002 is described as including both the encoder 1028 and the decoder 1038, in other embodiments, the device 1002 may include one of the encoder 1028 or the decoder 1038, and not the other. For example, the device 1002 may include the encoder 1028 and not the decoder 1038, such that the device 1002 is configured to encrypt and/or encode at least a portion of media content. As another example, the device 1002 may include the decoder 1038 and not the encoder 1028, such that the device 1002 is configured to decode and/or decrypt encoded media content.

The modem 1018 is coupled to the processor 108 and is configured to transmit or receive media content (e.g., the encoded output data 162). For example, the modem 1018 may transmit the media content to a second device, or receive the media content from the second device. In some embodiments, the modem 1018 includes or corresponds to an interface configured to receive the encoded output data 162 and provide the encoded output data 162 to the processor 108. In some examples, the interface includes a wired interface, such as a bus interface, a wired network interface, a cable interface, or a combination thereof. In some other examples, the interface includes a wireless interface, such as a wireless transceiver, a cellular modem, a Wi-Fi interface, a Bluetooth interface, or a combination thereof. In some embodiments, the interface may include or correspond to the interface described with reference to the device 902 of FIG. 9A, and the processor 108 (e.g., the decoder 1038) is configured to generate an output image frame based on the encoded output data 162 in a manner similar to that described with reference to FIG. 9A.

The processor 108 is also coupled to an image sensor 1012, an input device 1014 (e.g., a microphone, a keyboard or touch screen, etc.), a display device 1016, and a speaker 1017. The image sensor 1012 may include one or more cameras and may be configured to generate input media data, such as the image data 140 or the input image frame 142. Video content, such as the encoded output data 162, may be generated by the processor 108 at least partially based on the input media data.

The input device 1014 is configured to receive an input and provide the input to the processor 108 as input data 1015. For example, the input device 1014 may include a keyboard, a touch screen, or a microphone configured to receive the input and provide the input data 1015 (e.g., an input signal) to the processor 108. The input data 1015 may indicate to store or modify an entry at the content encryption configuration 130, generate image data 140, store or transmit the encoded output data 162, decode and/or decrypt the encoded output data 162, or present the encoded output data 162 or the output image frame 940. In some implementations, the image sensor 1012 (e.g., one or more cameras) may generate the image data 140 based on (or in response to) the input data 1015.

The display device 1016 is coupled to the processor 108 and is configured to output the output image frame 940 generated based on the encoded output data 162. For example, the display device 1016 may output display data based on the output image frame 940 (e.g., output media data). In some examples, the display device 1016 includes a display screen, a monitor or television, a projector, or a combination thereof. In some embodiments, the device 1002 (e.g., the processor 108) is configured to output audio associated with the output image frame 940 (e.g., video content). The speaker 1017 is coupled to the processor 108 and is configured to output audio associated with associated with the output image frame 940 (e.g., video content).

The image sensor 1012, the input device 1014, the display device 1016, the speaker 1017, or a combination there may be coupled to or integrated within the device 1002. Although the device 1002 is described as being coupled to or including the image sensor 1012, the input device 1014, the display device 1016, the speaker 1017, and the modem 1018, in other embodiments, one or more of these elements are optional, and in such embodiments, the device 1002 may not include or be coupled to the image sensor 1012, the input device 1014, the display device 1016, the speaker 1017, the modem 1018, or a combination thereof.

During operation of the system 1000, the processor 108 may perform one or more operations to identify and encrypt media content. For example, the processor 108 may use the protection controller 1010, the media generator 1020, and the encoder 1028 to perform one or more operations as described herein at least with reference to FIGS. 1-8E to identify and encrypt media content. Additionally, or alternatively, during operation of the system 1000, the processor 108 may perform one or more operations to decrypt media content. For example, the processor 108 may use the protection controller 1010, the media generator 1020, and the decoder 1038 to perform one or more operations as described herein at least with reference to FIGS. 9A-9B to decrypt media content that is encrypted.

In some embodiments, a device (e.g., the device 1002) includes a memory (e.g., the memory 106) and one or more processors (e.g., the processor 108). The memory is configured to store a content encryption configuration (e.g., the content encryption configuration 130) that indicates an object class (e.g., the object class 107), an encryption condition (e.g., the condition 131), and a status (e.g., the status 133). The one or more processors are configured to obtain contextual information (e.g., the contextual data 132) associated with input media data (e.g., the image data 140 or the input image frame 142), and determine whether the encryption condition is satisfied based on the contextual information. The one or more processors are further configured to, based on a determination that the encryption condition is satisfied, change the status of the content encryption configuration to active. The one or more processors are also configured to encrypt, based on the encryption key, a portion of the input media data that includes the instance of the object class to generate encrypted media data (e.g., encrypted ROI content 148).

In some examples, the device 1002 corresponds to or is included in one of various types of devices, such that the processor 108 can be integrated in multiple types of devices. In an illustrative example, the processor 108 is integrated in a wearable electronic device as depicted in FIG. 13, a virtual reality, mixed reality, or augmented reality headset as depicted in FIG. 16, a mixed reality or augmented reality glasses device as described with reference to FIG. 17, or another wearable device. In another illustrative example, the processor 108 is integrated in a mobile device (a mobile phone or a tablet computer) as depicted in FIG. 12, a voice-controlled speaker system as depicted in FIG. 14, a camera as depicted in FIG. 15, a vehicle as depicted in FIGS. 18 or 19 , a computer (e.g., a laptop computer) or a server, or another system or device.

FIG. 11 depicts a diagram of an example of an integrated circuit 1100 operable to encrypt or decrypt media content, in accordance with some examples of the present disclosure. The integrated circuit 1100 includes one or more processors 1108 (herein after referred to as the “processor 1108”) and a memory 1106. The processor 1108 and the memory 1106 may include or correspond to the processor 108 and the memory 106, respectively. The processor 1108 may include a protection controller 1110, a media generator 1120, an encoder 1128, a decoder 1129, or a combination thereof. The protection controller 1110, the media generator 1120, the encoder 1128, and the decoder 1129 may include or correspond to the protection controller 110, 910, or 1010, the media generator 120, 920, or 1020, the encoder 128 or 1028, and the decoder 938 or 1038, respectively. The memory 1106 includes (e.g., stores) content encryption configuration 1130. The content encryption configuration 1130 may include or correspond to the content encryption configuration 130. The content encryption configuration 1130 can include or indicate a condition, such as the condition 131.

The integrated circuit 1100 also includes an input interface 1104, such as one or more bus interfaces, to enable the integrated circuit 1100 to receive signals that represent input data 1170 for processing. For example, the input data 1170 can correspond to or include the image data 140, the input image frame 142, the contextual data 132, the content protection indicator 135, the output data 160, the encoded output data 162, the content encryption configuration 1130, or a combination thereof. In some embodiments, the input interface 1104 is configured to receive the encoded output data 162 and provide the encoded output data 162 to the processor 1108. In some examples, the input interface 1104 includes a wired interface, such as a bus interface, a wired network interface, a cable interface, or a combination thereof. In some other examples, the input interface 1104 includes a wireless interface, such as a wireless transceiver, a cellular modem, a Wi-Fi interface, a Bluetooth interface, or a combination thereof. In some embodiments, the input interface 1104 may include or correspond to the interface described with reference to the device 902 of FIG. 9A or the interface described with reference to the device 1002 of FIG. 10, and the processor 1108 (e.g., the decoder 1129) is configured to generate an output image frame based on the encoded output data 162 in a manner similar to that described with reference to FIG. 9A.

The integrated circuit 1100 also includes an output interface 1105, such as a bus interface, to enable the integrated circuit 1100 to output signals that represent output data 1172. For example, the output data 1172 can correspond to or include the image data 140, the input image frame 142, the contextual data 132, the content protection indicator 135, the output data 160, the encoded output data 162, the content encryption configuration 1130, or a combination thereof.

The integrated circuit 1100 including protection controller 1110, the media generator 1120, the encoder 1128, and the decoder 1129, or a combination thereof, and the content encryption configuration 130 enables implementation of encryption or decryption of media content as a component in a system or a device. For example, the system or the device may include a mobile device (e.g., a mobile phone or tablet) as depicted in FIG. 12, a wearable electronic device as depicted in FIG. 13, a voice-controlled speaker system as depicted in FIG. 14, a camera as depicted in FIG. 15, a virtual reality, mixed reality, or augmented reality headset as depicted in FIG. 16, a mixed reality or augmented reality glasses device, as described with reference to FIG. 17, or a vehicle as depicted in FIGS. 18 or 19 .

In some embodiments, the system or the device that includes the integrated circuit 1100 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 1012, the input device 1014, the display device 1016, the speaker 1017, and the modem 1018, respectively.

In some embodiments, the system or the device that includes the integrated circuit 1100 is operable to obtain contextual information associated with input media data; determine whether an encryption condition is satisfied based on the contextual information; and encrypt, based on the encryption condition being satisfied, a portion of the input media data that includes an instance of an object class to generate encrypted media data.

In some embodiments, the system or the device that includes the integrated circuit 1100 is operable to obtain output media data that includes encrypted media data including an encrypted portion of media data. The encrypted portion of the media data is associated with an object class. The system or the device that includes the integrated circuit 1100 is further operable to decrypt, based on a key, the encrypted portion of the media data to obtain a portion of the media data.

FIG. 12 depicts a diagram of a mobile device 1200 operable to encrypt or decrypt media content, in accordance with some examples of the present disclosure. The mobile device 1200 may include or correspond to a phone or a tablet computer device, as illustrative, non-limiting examples. The mobile device 1200 includes a camera 1202 (e.g., an image sensor), a display 1204 (e.g., a display screen), a microphone 1206, a speaker 1208, and the integrated circuit 1100. Components of the integrated circuit 1100, including the protection controller 1110, the media generator 1120, the encoder 1128, the decoder 1129, or a combination thereof, are integrated in the mobile device 1200 and are illustrated using dashed lines to indicate internal components that are not generally visible to a user of the mobile device 1200.

FIG. 13 depicts a diagram of a wearable electronic device 1300 operable to encrypt or decrypt media content, in accordance with some examples of the present disclosure. The wearable electronic device 1300 may include or correspond to a “smart watch,” as an illustrative, non-limiting example. The wearable electronic device 1300 includes a camera 1302 (e.g., an image sensor), a display 1304 (e.g., a display screen), a microphone 1306, a speaker 1308, and the integrated circuit 1100. Components of the integrated circuit 1100, including the protection controller 1110, the media generator 1120, the encoder 1128, the decoder 1129, or a combination thereof, are integrated in the wearable electronic device 1300 and are illustrated using dashed lines to indicate internal components that are not generally visible to a user of the wearable electronic device 1300.

FIG. 14 is a diagram of a voice-controlled speaker system 1400 operable to encrypt or decrypt media content, in accordance with some examples of the present disclosure. The voice-controlled speaker system 1400 may include or correspond to a wireless speaker and voice activated device, as an illustrative, non-limiting example. The voice-controlled speaker system 1400 can have wireless network connectivity and is configured to execute an assistant operation. The voice-controlled speaker system 1400 includes a camera 1402 (e.g., an image sensor), a display 1404 (e.g., a display screen), a microphone 1406, a speaker 1408, and the integrated circuit 1100. Components of the integrated circuit 1100, including the protection controller 1110, the media generator 1120, the encoder 1128, the decoder 1129, or a combination thereof, are integrated in the voice-controlled speaker system 1400 and are illustrated using dashed lines to indicate internal components that are not generally visible to a user of the voice-controlled speaker system 1400.

FIG. 15 is a diagram of a camera device 1500 operable to encrypt or decrypt media content, in accordance with some examples of the present disclosure. The camera device 1500 includes an image sensor 1502, a display 1504 (e.g., a display screen), a microphone 1506, a speaker 1508, and the integrated circuit 1100. Components of the integrated circuit 1100, including the protection controller 1110, the media generator 1120, the encoder 1128, the decoder 1129, or a combination thereof, are integrated in the camera device 1500 and are illustrated using dashed lines to indicate internal components that are not generally visible to a user of the camera device 1500.

FIG. 16 is a diagram of a headset 1600, such as a virtual reality, mixed reality, or augmented reality headset, operable to encrypt or decrypt media content, in accordance with some examples of the present disclosure. A visual interface device is positioned in front of the user's eyes to enable display of augmented reality, mixed reality, or virtual reality images or scenes to the user while the headset 1600 is worn. The headset 1600 also includes a camera 1602 (e.g., an image sensor), a display 1604 (e.g., a display screen), a microphone 1606, a speaker 1608, and the integrated circuit 1100. Components of the integrated circuit 1100, including the protection controller 1110, the media generator 1120, the encoder 1128, the decoder 1129, or a combination thereof, are integrated in the headset 1600 and are illustrated using dashed lines to indicate internal components that are not generally visible to a user of the headset 1600.

FIG. 17 is a diagram of a mixed reality or augmented reality glasses device 1700 operable to encrypt or decrypt media content, in accordance with some examples of the present disclosure. The glasses 1700 include a holographic projection unit 1704 configured to project visual data onto a surface of a lens 1705 or to reflect the visual data off of a surface of the lens 1705 and onto the wearer’s retina. The glasses 1700 also include a camera 1702 (e.g., an image sensor), a microphone 1706, one or more speakers 1708, and the integrated circuit 1100. Components of the integrated circuit 1100, including the protection controller 1110, the media generator 1120, the encoder 1128, the decoder 1129, or a combination thereof, are integrated in the glasses 1700 and are illustrated using dashed lines to indicate internal components that are not generally visible to a user of the glasses 1700.

FIG. 18 is a diagram of a first example of a vehicle 1800 operable to encrypt or decrypt media content, in accordance with some examples of the present disclosure. The vehicle 1800 may include or correspond to a manned or unmanned aerial device (e.g., a package delivery drone). The vehicle 1800 includes a camera 1802 (e.g., an image sensor), a display 1804 (e.g., a display screen), a microphone 1806, a speaker 1808, and the integrated circuit 1100. Components of the integrated circuit 1100, including the protection controller 1110, the media generator 1120, the encoder 1128, the decoder 1129, or a combination thereof, are integrated in the vehicle 1800 and are illustrated using dashed lines to indicate internal components that are not generally visible to a user of the vehicle 1800.

FIG. 19 is a diagram of a second example of a vehicle 1900 operable to encrypt or decrypt media content, in accordance with some examples of the present disclosure. The vehicle 1900 may include or correspond to a car. The vehicle 1900 includes a camera 1902 (e.g., an image sensor), a display 1904 (e.g., a display screen), a microphone 1906, one or more speakers 1908, and the integrated circuit 1100. Components of the integrated circuit 1100, including the protection controller 1110, the media generator 1120, the encoder 1128, the decoder 1129, or a combination thereof, are integrated in the vehicle 1900 and are illustrated using dashed lines to indicate internal components that are not generally visible to a user of the vehicle 1900.

Although the examples of the vehicle of FIGS. 18 and 19 are describe an aerial device and a car, respectively, in other examples, the vehicle can correspond to an aircraft (such as a fixed wing aircraft, a rotary wing aircraft, an aerostat, a hybrid aircraft, spaceship, or another type of aircraft), a land craft (such as a car, a truck, or another type of land craft), or a watercraft (such as a boat, a submersible, a ship, a barge, a ferry, or another type of watercraft). Further, the watercraft, the aircraft, the land craft, or watercraft can be manned or unmanned (e.g., crewed or uncrewed).

In a particular example of one or more of the devices of FIGS. 12-19, the integrated circuit 1100 (e.g., the media generator 1120 and the encoder 1128) is operable to generate media data (e.g., the encoded output data 162). To illustrate, the protection controller 1110 may determine that the condition 131 is satisfied based on the contextual data 132 and enable the media generator 1120 to detect an instance of the object class 107 (associated with the condition 131) included media content. For example, based on the media content received from a camera or a speaker of the device, the media generator 1120 can detect the instance of the object class 107 and generate the masked image frame 144, the encrypted ROI content 148, or a combination thereof. Additionally, the encoder 1128 generates the encoded output data 162, such as a bitstream, that includes or indicates the masked image frame 144, the encrypted ROI content 148, the indicator 607, or a combination thereof. The encoded output data 162 may be stored at the memory 1106, sent to another device via a modem coupled to the integrated circuit 1100, output via a display or speaker of the one or more devices of FIG. 10 or FIGS. 12-19, or a combination thereof. One technical advantage of the integrated circuit 1100 (e.g., the protection controller 1110 and/or the media generator 1120) implemented by the one or more devices of FIGS. 12-19 as described above is that sensitive content (partial video) included in the input image frame 142 may be selectively encrypted in accordance with the condition 131. Another technical advantage of the integrated circuit 1100 (e.g., the media generator 1120) implemented by the one or more devices of FIGS. 12-19 as described above is that automatic sensitive content (partial video) encryption may be performed on the input image frame 142, such as when the video is captured for the first time. The partial video encryption can allow for storage, transmission, and playback using the same encoded output data 162 (e.g., the same encrypted bitstream) both where access to encrypted ROI content 148 is authorized (e.g., playback includes unencrypted sensitive content) and where access to the encrypted ROI content 148 is non-authorized (e.g., playback includes a masked version of the sensitive content).

In a particular example of one or more of the devices of FIGS. 12-19, the integrated circuit 1100 (e.g., the media generator 1120 and the decoder 1129) is operable to selectively decode the encoded output data 162 and decrypt the encrypted ROI content 148. For example, the decoder 1129 may receive and decode the encoded output data 162. The media generator 1120 can decrypt the encrypted ROI content 148 based on the key 137 and then combine the decrypted ROI content (e.g., the ROI content 146) with the masked image frame 144 to thereby obtain the input image frame 142 (e.g., an original input image frame). The obtained input image frame 142 (e.g., the original input image frame) may be stored at the memory 1106, sent to another device via a modem coupled to the integrated circuit 1100, output via a display or speaker of the one or more devices of FIGS. 10 or 12-19, or a combination thereof. It is noted that if the key 137 is unavailable to decrypt the encrypted ROI content 148, the masked image frame 144 may be displayed, or the encrypted ROI content 148 and the masked image frame 144 may be stored at the memory 1106. One technical advantage of the integrated circuit 1100 (e.g., the media generator 1120) implemented by the one or more devices of FIGS. 12-19 as described above is that the same encoded output data 162 (e.g., the same encrypted bitstream) can allow for storage, transmission, and/or playback of media content, with sensitive content either being masked (e.g., a masked portion) or non-masked (e.g., a non-masked portion) based on whether access to the encrypted ROI content 148 is authorized or non-authorized.

The embodiments of the systems or devices as described with reference to FIGS. 12-19 are described, respectively, as including a display, a microphone, a speaker, a camera, or a combination thereof. As described with reference to FIGS. 12-19, the display, the microphone, the speaker, and the camera may include or correspond to the display device 1016, the input device 1014, the speaker 1017, and the image sensor 1012, respectively. It is noted that in other embodiments of the systems or devices of FIGS. 12-19, one or more of the systems or devices of FIGS. 12-19 may not include the display, the microphone, the speaker, the camera, or a combination thereof. Additionally, or alternatively, one or more of the systems or devices of FIGS. 12-19 may include an additional component. For example, the additional component may include a modem, such as the modem 1018.

FIG. 20 is a diagram of an example of a method 2000 of encryption of media content, in accordance with some aspects of the present disclosure. In a particular aspect, one or more operations of the method 2000 are performed by the system 100 or 1000, the device 102 or 1002, the processor 108, the protection controller 110, 1010, or 1110, the media generator 120, 1020, or 1120, the encoder 128, 1028, or 1128, the integrated circuit 1100, the mobile device 1200, the wearable electronic device 1300, the voice-controlled speaker system 1400, the camera device 1500, the headset 1600, the glasses 1700, the vehicle 1800 or 1900, or a combination thereof.

In some embodiments, the method 2000 includes, at block 2002, obtaining a content encryption configuration indicating an object class, an encryption condition, and a status that indicates whether the content encryption configuration is active or inactive. The content encryption configuration may include or correspond to the content encryption configuration 130 or one of the entries 221, 242, or 263. The object class and the encryption condition may include or correspond to the object class 107 and the condition 131 or 210, respectively. The status may include or correspond to the status 133 or 239.

In some embodiments, the method 2000 may include accessing the content encryption configuration. In some examples, the content encryption configuration includes a first configuration that indicates the object class and the encryption condition. The content encryption configuration may also include a second configuration. The second configuration may indicate a second object class, a second encryption condition, or a combination thereof. The second object class may be different from the object class.

At block 2004, the method includes obtaining contextual information associated with input media data. For example, the contextual information may include or correspond to the contextual data 132. The contextual information may include position data associated with a device, a wireless network identifier, environment data that indicates an environment associated with the input media data, object data that indicates an object included in the input media data, or a combination thereof. Additionally, or alternatively, the contextual information is obtained from a positioning system, map data, a wireless network detector, an object detector configured to detect a conditional object included in the input media data, or a combination thereof. The input media data may include or correspond to the image data 140 or the input image frame 142. The input media data may include image data, audio data, or a combination thereof. In some examples, the input media data represents an image frame. In some embodiments, the method 2000 includes obtaining the input media data.

At block 2006, the method 2000 also includes determining whether the encryption condition is satisfied based on the contextual information. The encryption condition indicates to encrypt the object class based on a physical space or an environment, such as a physical space or environment associated with an office, a public space, an outdoor space, a restricted area, or a particular geographic location. Additionally, or alternatively, the encryption condition may indicate to encrypt the object class based on an object, availability of a particular wireless network, a positioning system, or a combination thereof. In some embodiments, the object class includes a document, a whiteboard, a poster, a computer screen, a display device, a person, a human face, a body part, an animal, an address, a street name, a weapon, a type of weapon, or a combination thereof. Additionally, or alternatively, the object class includes a vehicle, a type of vehicle, a vehicle manufacturer, a vehicle model, a vehicle license plate, or a combination thereof. In some other embodiments, the object class includes all content of the input media data. In some embodiments, the encryption condition indicates to encrypt the object class based on the object class being located on a building, a document, a sign, or a vehicle.

At block 2010, the method 2000 includes, based on a determination that the encryption condition is satisfied, changing the status of the content encryption configuration to active. For example, the method 2000 may also include determining whether the content encryption configuration is active or inactive. In some embodiments, if the status of the content encryption configuration is inactive, the method 2000 may include changing the status of the content encryption configuration to active based on a determination that the encryption condition is satisfied. Alternatively, if the status of the content encryption configuration is active, the method 2000 may include changing the status of the content encryption configuration to inactive based on a determination that the encryption condition is unsatisfied.

At block 2010, the method 2000 further includes encrypting, based on the encryption condition being satisfied, a portion of the input media data that includes an instance of the object class to generate encrypted media data. The encrypted media data may include or correspond to the encrypted ROI content 148, the encoded encrypted ROI content 618, or the encrypted ROI frame 548 or 736.

The method 2000 may also include detecting the instance of the object class within input media data. Additionally, or alternatively, the method 2000 includes generating output media data that includes the encrypted media data. The output media data may include or correspond to the masked image frame 144 or 544, the encrypted ROI content 148 or 732, the encrypted ROI frame 548, the output data 160, the encoded output data 162, the content protection data 164, the encoded masked image frame 614, the encoded encrypted ROI content 618, the encoded segmentation frame 655, the encrypted ROI frame 736, or the ROI segmentation frame 755.

In some embodiments, the output media data includes an indicator. For example, the indicator may include or correspond to the indicator 607. The indicator may indicate an encryption key, the encrypted media data, a content encryption configuration, the object class, a device identifier or a user of the device, or a combination thereof. In some embodiments, the output media data includes a bitstream. Additionally, or alternatively, the output media data may include content protection data. For example, the content protection data may include or correspond to the content protection data 164 or the content protection indicator 935. The content protection data may be included in a header of the output media data, metadata of the output media data, or a combination thereof. In some examples, the content protection data includes the indicator.

In some embodiments, the method 2000 includes obtaining, based on the encryption condition being satisfied, an encryption key for the object class. For example, the encryption key may include or correspond to the key 137. The portion of the input media data may be encrypted based on the encryption key. In some embodiments, the encryption key includes a random key. The content encryption configuration may indicate the encryption key and the encryption key may be obtained from the content encryption configuration. Additionally, or alternatively, the encryption key may be generated for the object class indicated by the content encryption configuration. For example, the encryption key can be generated based on a determination that the content encryption configuration is active.

In some embodiments, the method 2000 includes masking the portion of the input media data to generate a masked version of the input media data. The masked version of the input media data may include or correspond to the masked image frame 144 or 544 or the encoded masked image frame 614. In some embodiments, the output media data includes the masked version of the input media data.

In some embodiments, the method 2000 includes detecting the instance of the second object class within input media data. The method 2000 may also include encrypting a second portion of the input media data that includes the instance of the second object class to generate second encrypted media data. The portion of the input media data and the second portion of the input media data may be different portions of the same image frame. The method 2000 can also include generating output media data that includes the second encrypted media data, and an encrypted version of the second encryption key encrypted.

In some embodiments, the method 2000 includes generating, based on the input media data and detection of the object class, segmentation data. For example, the segmentation may include or correspond to the encoded segmentation frame 655, the ROI segmentation frame 755, or a combination thereof. In some such embodiments, the output media data includes the segmentation data. Additionally, the output media data may include a non-display indicator associated with the segmentation data. In some embodiments, the method 2000 includes combining the segmentation data, the encrypted media data, and the masked version of the input media data to generate the combined media data. The combined media data may include or correspond to the output data 160. To combine the segmentation data, the encrypted media data, and the masked version of the input media data, the method 2000 can include concatenating together the segmentation data, the encrypted media data, and the masked version of the input media data to generate the combined media data. The method 2000 may include providing, to an encoder, the combined media data, one or more encoder settings, or a combination thereof. The encoder may include or correspond to the encoder 128, 1028, or 1028.

In some embodiments, the method 2000 includes obtaining the input media data. For example, to obtain the input media data, the method 2000 may include receiving or retrieving the input media data from a memory, such as the memory 106. In other embodiments, to obtain the input media data, the method 2000 may include receiving the input media data from a generation device, such as a camera, a microphone, or a combination thereof. For example, in some embodiments, the method 2000 includes generating, by one or more cameras, the input media data. The one or more cameras may include or correspond to the image sensor 1012. In some such embodiments, the method 2000 includes receiving, via an input device, an input and providing the input to a processor (e.g., the processor 108). For example, the input device and the input may include or correspond to the input device 1014 and the input data 1015, respectively. In some implementations, the input includes a request to generate the input media data. The method 2000 may include activating, based on the input data, the one or more cameras to generate the input media data.

In some embodiments, the method 2000 includes storing the output media data at a memory, such as the memory 106. Additionally, or alternatively, the method 2000 can include outputting, via a display device, display data based on the output media data. For example, the display device may include or correspond to the display device 1016.

In some embodiments, the method 2000 includes sending the output media data to a decoder device. Additionally, or alternatively, the method 2000 can include transmitting, via a modem, the output media data to a decoder device. For example, the modem may include or correspond to the modem 1018. The decoder device may include or correspond to the device 902 or the decoder 938 or 1038.

The method 2000 of FIG. 20 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 2000 of FIG. 20 may be performed by a processor that executes instructions, such as described with reference to FIG. 21.

It is noted that one or more blocks (or operations) described with reference to FIGS. 3, 4, 9B, and /or 20, may be combined with one or more blocks (or operations) described with reference to another of the figures. For example, one or more blocks (or operations) of FIG. 3 may be combined with one or more blocks (or operations) of FIGS. 4, 9B, or 20, . As another example, one or more blocks (or operations) of FIG. 4 may be combined with one or more blocks (or operations) of FIGS. 9B or 20 . As another example, one or more blocks (or operations) of FIG. 9B may be combined with one or more blocks (or operations) of FIG. 20. As another example, one or more blocks (or operations) of FIGS. 3, 4, 9B, and /or 20, may be combined with one or more blocks (or operations) of FIGS. 1, 7A, 9A, 10, or 11, . As another example, one or more blocks associated with FIGS. 3, 4, 9B, and/ or 20, may be combined with one or more blocks (or operations) associated with another of FIGS. 1-19. Additionally, or alternatively, one or more operations described above with reference to FIGS. 1-20 may be combined with one or more operations described with reference to FIG. 21.

Referring to FIG. 21, FIG. 21 is a block diagram of an illustrative example of a device 2100 that is operable to encrypt media content, in accordance with one or more aspects of the present disclosure. In various implementations, the device 2100 may have more or fewer components than illustrated in FIG. 21. In an illustrative implementation, the device 2100 may correspond to the device 102, 902, or 1002, the integrated circuit 1100, or a device of any of FIGS. 12-19. In an illustrative implementation, the device 2100 may perform one or more operations described with reference to FIGS. 1-20.

In a particular implementation, the device 2100 includes a processor 2106 (e.g., a central processing unit (CPU)). The device 2100 may include one or more additional processors 2110 (e.g., one or more DSPs). In a particular aspect, the processor 108 of FIG. 1 or the processor 1108 of FIG. 11 corresponds to the processor 2106, the processors 2110, or a combination thereof. The processors 2110 may include a speech and music coder-decoder (CODEC) 2108 that includes a voice coder (“vocoder”) encoder 2136, a vocoder decoder 2138, or a combination thereof. Additionally, or alternatively, the processors 2110 may include a protection controller 2180, a media generator 2181, an encoder 2182, a decoder 2183, or a combination thereof. The protection controller 2180 may include or correspond to the protection controller 110, 910, 1010, or 1110. The media generator 2181 may include or correspond to the media generator 120, 920, 1020, or 1120. The encoder 2182 may include or correspond to the encoder 128, 1028, or 1128. The decoder 2183 may include or correspond to the decoder 938, 1038, or 1129.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor’s ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 2100 may include a memory 2186 and a CODEC 2134. The memory 2186 may include or correspond to the memory 106 or 1106. The memory 2186 may include instructions 2156, that are executable by the one or more additional processors 2110 (or the processor 2106) to implement the functionality described with reference to the protection controller 2180, the media generator 2181, the encoder 2182, the decoder 2183, or a combination thereof. The instructions 2156 may include or correspond to the instructions 109. The memory 2186 also may include content encryption configuration data 2157. The content encryption configuration data 2157 may include or correspond to the content encryption configuration 130. The content encryption configuration data 2157 includes or indicates a condition 2131. For example, the condition 2131 may include or correspond to the condition 131 or the condition 210. Additionally, or alternatively, the content encryption configuration data 2157 may include or indicate a status. For example, the status may include or correspond to the status 133. The device 2100 may include a modem 2170 coupled, via a transceiver 2150, to an antenna 2152. The modem 2170 may include or correspond to the modem 1018. In some embodiments, the device 2100 includes an interface configured to receive the encoded output data 162 and provide the encoded output data 162 to the processor 2106, the processors 2110, or a combination thereof. In some examples, the interface includes a wired interface, such as a bus interface, a wired network interface, a cable interface, or a combination thereof. In some other examples, the interface includes a wireless interface, such as a wireless transceiver, a cellular modem, a Wi-Fi interface, a Bluetooth interface, or a combination thereof. In some embodiments, the interface includes or corresponds to the modem 2170, the transceiver 2150, or a combination thereof. In some examples, the interface may include or correspond to the interface described with reference to the device 902 of FIG. 9A, the device 1002 of FIG. 10, or the integrated circuit 1100 of FIG. 11, and the decoder 2183 is configured to generate an output image frame based on the encoded output data 162 in a manner similar to that described with reference to FIG. 9A.

The device 2100 may include a display 2128 coupled to a display controller 2126. The display 2128 may include or correspond to the display device 1016. One or more speakers 2192, one or more microphone(s) 2194, or both, may be coupled to the CODEC 2134. The microphone(s) 2194 may include or correspond to the input device 1014. The CODEC 2134 may include a digital-to-analog converter (DAC) 2102, an analog-to-digital converter (ADC) 2104, or both. In a particular implementation, the CODEC 2134 may receive analog signals from the microphone(s) 2194, convert the analog signals to digital signals using the analog-to-digital converter 2104, and provide the digital signals to the speech and music codec 2108. The speech and music codec 2108 may process the digital signals, and the digital signals may further be processed by the protection controller 2180, the media generator 2181, the encoder 2182, the decoder 2183, or a combination thereof. In a particular implementation, the speech and music codec 2108 may provide digital signals to the CODEC 2134. The CODEC 2134 may convert the digital signals to analog signals using the digital-to-analog converter 2102 and may provide the analog signals to the speaker 2192. The speaker 2192 may include or correspond to the speaker 1017.

In a particular implementation, the device 2100 may be included in a system-in-package or system-on-chip device 2122. In a particular implementation, the memory 2186, the processor 2106, the processors 2110, the display controller 2126, the CODEC 2134, and the modem 2170 are included in the system-in-package or system-on-chip device 2122. In a particular implementation, an input device 2130, a power supply 2144, and a camera 2145 are coupled to the system-in-package or the system-on-chip device 2122. For example, the input device 2130 and the camera 2145 may include or correspond to the input device 1014 and the image sensor 1012, respectively. In some examples, the input device 2130 may include or be associated with the display device 1016 or the display 2128. Moreover, in a particular implementation, as illustrated in FIG. 21, the display 2128, the input device 2130, the speaker(s) 2192, the microphone(s) 2194, the antenna 2152, the power supply 2144, and the camera 2145 are external to the system-in-package or the system-on-chip device 2122. In a particular implementation, each of the display 2128, the input device 2130, the speaker(s) 2192, the microphone(s) 2194, the antenna 2152, the power supply 2144, and the camera 2145 may be coupled to a component of the system-in-package or the system-on-chip device 2122, such as an interface or a controller.

The device 2100 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, an earbud, a hearing aid, a car, a computing device, a communication device, an internet-of-things (IoT) device, a virtual reality (VR) device, a base station, a mobile device, or any combination thereof.

In conjunction with the described implementations, an apparatus includes means for obtaining a content encryption configuration indicating an object class, an encryption condition, and a status that indicates whether the content encryption configuration is active or inactive. For example, the means for obtaining can include the system 100 or 1000, the device 102 or 1002, the memory 106, 1106, or 2186, the processor 108 or 1108, the protection controller 110, 1010, 1110, or 2180, the media generator 120, 1020, 1120, or 2181, the integrated circuit 1100, the mobile device 1200, the wearable electronic device 1300, the voice-controlled speaker system 1400, the camera device 1500, the headset 1600, the glasses 1700, the vehicle 1800, the vehicle 1900, the processor 2106, the processor(s) 2110, the system-in-package or the system-on-chip device 2122, the device 2100, other circuitry configured to obtain the content encryption configuration, or a combination thereof.

The apparatus further includes means for obtaining contextual information associated with input media data. For example, the means for obtaining the contextual information can include the system 100 or 1000, the device 102 or 1002, the processor 108 or 1108, the protection controller 110, 1010, 1110, or 2180, the media generator 120, 1020, 1120, or 2181, the integrated circuit 1100, the mobile device 1200, the wearable electronic device 1300, the voice-controlled speaker system 1400, the camera device 1500, the headset 1600, the glasses 1700, the vehicle 1800, the vehicle 1900, the processor 2106, the processor(s) 2110, the system-in-package or the system-on-chip device 2122, the device 2100, other circuitry configured to obtain the contextual information, or a combination thereof.

The apparatus also includes means for determining whether the encryption condition is satisfied based on the contextual information. For example, the means for determining can include the system 100 or 1000, the device 102 or 1002, the processor 108 or 1108, the protection controller 110, 1010, 1110, or 2180, the media generator 120, 1020, 1120, or 2181, the integrated circuit 1100, the mobile device 1200, the wearable electronic device 1300, the voice-controlled speaker system 1400, the camera device 1500, the headset 1600, the glasses 1700, the vehicle 1800, the vehicle 1900, the processor 2106, the processor(s) 2110, the system-in-package or the system-on-chip device 2122, the device 2100, other circuitry configured to determine whether the encryption condition is satisfied, or a combination thereof.

The apparatus includes means for changing, based on a determination that the encryption condition is satisfied, the status of the content encryption configuration to active. For example, the means for changing can include the system 100 or 1000, the device 102 or 1002, the memory 106, 1106, or 2186, the processor 108 or 1108, the protection controller 110, 1010, 1110, or 2180, the media generator 120, 1020, 1120, or 2181, the integrated circuit 1100, the mobile device 1200, the wearable electronic device 1300, the voice-controlled speaker system 1400, the camera device 1500, the headset 1600, the glasses 1700, the vehicle 1800, the vehicle 1900, the processor 2106, the processor(s) 2110, the system-in-package or the system-on-chip device 2122, the device 2100, other circuitry configured to change the status, or a combination thereof.

The apparatus further includes means for encrypting, based on the encryption condition being satisfied, a portion of the input media data that includes an instance of the object class to generate encrypted media data. For example, the means for encrypting the portion of the input media data can include the system 100 or 1000, the device 102 or 1002, the processor 108 or 1108, the protection controller 110, 1010, 1110, or 2180, the media generator 120, 1020, 1120, or 2181, the encryptor 124, the integrated circuit 1100, the mobile device 1200, the wearable electronic device 1300, the voice-controlled speaker system 1400, the camera device 1500, the headset 1600, the glasses 1700, the vehicle 1800, the vehicle 1900, the processor 2106, the processor(s) 2110, the system-in-package or the system-on-chip device 2122, the device 2100, other circuitry configured to encrypt the portion of the input media data, or a combination thereof.

In some implementations, a non-transitory computer-readable medium (e.g., a computer-readable storage device, such as the memory 2186) includes instructions (e.g., the instructions 2156) that, when executed by one or more processors (e.g., the one or more processors 2110 or the processor 2106), cause the one or more processors to obtain a content encryption configuration indicating an object class, an encryption condition, and a status that indicates whether the content encryption configuration is active or inactive. The instructions also cause the one or more processors to obtain contextual information associated with input media data, and determine whether the encryption condition (e.g., the condition 2131) is satisfied based on the contextual information. The instructions further cause the one or more processors to, based on a determination that the encryption condition is satisfied, change the status of the content encryption configuration to active. The instructions further cause the one or more processors to encrypt, based on the encryption condition being satisfied, a portion of the input media data that includes an instance of the object class to generate encrypted media data.

Particular aspects of the disclosure are described below in sets of interrelated Examples:

According to Example 1, a device includes: a memory configured to store a content encryption configuration that indicates an object class, an encryption condition, and a status that indicates whether the content encryption configuration is active or inactive; and one or more processors configured to: obtain contextual information associated with input media data; determine whether the encryption condition is satisfied based on the contextual information; based on a determination that the encryption condition is satisfied, change the status of the content encryption configuration to active; and based on the encryption condition being satisfied, encrypt a portion of the input media data that includes an instance of the object class to generate encrypted media data.

Example 2 includes the device of Example 1, where: the contextual information includes a wireless network identifier, and the contextual information is obtained from a wireless network detector.

Example 3 includes the device of Example 1, where: the contextual information includes position data associated with the device, indicates an environment associated with the input media data, indicates an object included in the input media data, or a combination thereof, and the contextual information is obtained from a positioning system, map data, an object detector configured to detect a conditional object included in the input media data, or a combination thereof.

Example 4 includes the device of any of Examples 1 to 3, where the encryption condition indicates to encrypt the object class based on a physical space associated with an office, availability of a particular wireless network, a location being associated with a restricted area, or an environment being an outdoor area or a public area.

Example 5 includes the device of any of Examples 1 to 4, where the encryption condition indicates to encrypt the object class based on a physical space, an environment, an object, a positioning system, or a particular geographic location.

Example 6 includes the device of any of Examples 1 to 5, where the encryption condition indicates to encrypt the object class based on the object class being located on a building, a document, a sign, a vehicle, or a combination thereof.

Example 7 includes the device of any of Examples 1 to 6, where the object class includes a document, a whiteboard, a poster, a computer screen, a display device, an address, a street name, or all content of the input media data.

Example 8 includes the device of any of Examples 1 to 7, where the object class includes a human face or a license plate.

Example 9 includes the device of any of Examples 1 to 8, where the one or more processors are configured to: access the content encryption configuration; and determine whether the status of the content encryption configuration is active or inactive; and change the status of the content encryption configuration from active to inactive based on a determination that the encryption condition is unsatisfied.

Example 10 includes the device of any of Examples 1 to 9, where the one or more processors configured to: obtain the input media data; detect the instance of the object class within input media data; based on the encryption condition being satisfied, obtain an encryption key for the object class, where the portion of the input media data is encrypted based on the encryption key; and generate output media data that includes the encrypted media data.

Example 11 includes the device of Example 10, where: the one or more processors configured to mask the portion of the input media data to generate a masked version of the input media data, and the output media data that includes the masked version of the input media data.

Example 12 includes the device of Example 10 or Example 11, where: the one or more processors configured to receive, from another device, the content encryption configuration, the status of the content encryption configuration obtained from the other device is inactive, and the output media data includes an indicator that indicates an encryption key, a public key, the encrypted media data, the content encryption configuration, the object class, a device identifier or a user of the device, or a combination thereof.

Example 13 includes the device of any of Examples 10 to 12, and further includes a display device coupled to the one or more processors and configured to output display data based on the output media data.

Example 14 includes the device of any of Examples 1 to 13, where the one or more processors are configured to store the encrypted media data at the memory.

Example 15 includes the device of any of Examples 1 to 14, where the one or more processors are configured to send the encrypted media data to a decoder device.

Example 16 includes the device of any of Examples 1 to 15, and further includes one or more cameras coupled to the one or more processors, and where the one or more cameras are configured to generate the input media data.

Example 17 includes the device of any of Examples 1 to 16, and further includes a modem coupled to the one or more processors, the modem configured to transmit the encrypted media data to a decoder device.

Example 18 includes the device of any of Examples 1 to 17, and further includes an input device configured to receive an input and provide the input to the one or more processors, where the input includes a request to generate the input media data.

Example 19 includes the device of any of Examples 1 to 18, where the one or more processors are integrated in a mobile phone, a tablet computer device, a wearable electronic device, a virtual reality headset, a mixed reality headset, an augmented reality headset, or a camera device.

Example 20 includes the device of any of Examples 1 to 18, where the one or more processors are integrated in a vehicle.

According to Example 21, a method includes: obtaining a content encryption configuration indicating an object class, an encryption condition, and a status that indicates whether the content encryption configuration is active or inactive; obtaining contextual information associated with input media data; determining whether an encryption condition is satisfied based on the contextual information; based on a determination that the encryption condition is satisfied, changing the status of the content encryption configuration to active; and based on the encryption condition being satisfied, encrypting a portion of the input media data that includes an instance of an object class to generate encrypted media data.

Example 22 includes the method of Example 21, where: the contextual information includes a wireless network identifier, and the contextual information is obtained from a wireless network detector.

Example 23 includes the method of Example 21, where: the contextual information includes position data associated with the device, indicates an environment associated with the input media data, indicates an object included in the input media data, or a combination thereof, and the contextual information is obtained from a positioning system, map data, an object detector configured to detect a conditional object included in the input media data, or a combination thereof.

Example 24 includes the method of any of Examples 21 to 23, where the encryption condition indicates to encrypt the object class based on a physical space associated with an office, availability of a particular wireless network, a location being associated with a restricted area, or an environment being an outdoor area or a public area.

Example 25 includes the method of any of Examples 21 to 24, where the encryption condition indicates to encrypt the object class based on a physical space, an environment, an object, a positioning system, or a particular geographic location.

Example 26 includes the method of any of Examples 21 to 25, where the encryption condition indicates to encrypt the object class based on the object class being located on a building, a document, a sign, a vehicle, or a combination thereof.

Example 27 includes the method of any of Examples 21 to 26, where the object class includes a document, a whiteboard, a poster, a computer screen, a display device, an address, a street name, or all content of the input media data.

Example 28 includes the method of any of Examples 21 to 27, where the object class includes a human face or a license plate.

Example 29 includes the method of any of Examples 21 to 28, and further includes: accessing the content encryption configuration; and determining whether the status of the content encryption configuration is active or inactive; and changing the status of the content encryption configuration from active to inactive based on a determination that the encryption condition is unsatisfied.

Example 30 includes the method of any of Examples 21 to 29, and further includes: obtaining the input media data; detecting the instance of the object class within input media data; based on the encryption condition being satisfied, obtaining an encryption key for the object class, where the portion of the input media data is encrypted based on the encryption key; and generating output media data that includes the encrypted media data.

Example 31 includes the method of Example 30, and further includes: masking the portion of the input media data to generate a masked version of the input media data, and where the output media data that includes the masked version of the input media data.

Example 32 includes the method of Example 30 or Example 31, and further includes: receiving, from another device, the content encryption configuration, where the status of the content encryption configuration obtained from the other device is inactive, and where the output media data includes an indicator that indicates an encryption key, a public key, the encrypted media data, the content encryption configuration, the object class, a device identifier or a user of the device, or a combination thereof.

Example 33 includes the method of any of Examples 30 to 32, and further includes outputting, via a display device, display data based on the output media data.

Example 34 includes the method of any of Examples 21 to 33, and further includes storing the encrypted media data at a memory.

Example 35 includes the method of any of Examples 21 to 34, and further includes sending the encrypted media data to a decoder device.

Example 36 includes the method of any of Examples 21 to 35, and further includes generating, via one or more cameras, the input media data.

Example 37 includes the method of any of Examples 21 to 36, and further includes transmitting, via a modem, the encrypted media data to a decoder device.

Example 38 includes the method of any of Examples 21 to 37, and further includes receiving, from an input device, an input that includes a request to generate the input media data.

Example 39 includes the method of any of Examples 21 to 38, where the method is performed by a mobile phone, a tablet computer device, a wearable electronic device, a virtual reality headset, a mixed reality headset, an augmented reality headset, or a camera device.

Example 40 includes the method of any of Examples 21 to 38, where the method is performed by a vehicle.

According to Example 41, a non-transitory computer readable stores instructions that are executable by one or more processors to cause the one or more processors to: obtaining a content encryption configuration indicating an object class, an encryption condition, and a status that indicates whether the content encryption configuration is active or inactive; obtain contextual information associated with input media data; determine whether an encryption condition is satisfied based on the contextual information; based on a determination that the encryption condition is satisfied, change the status of the content encryption configuration to active; and based on the encryption condition being satisfied, encrypt a portion of the input media data that includes an instance of an object class to generate encrypted media data.

Example 42 includes the non-transitory computer readable of Example 41, where: the contextual information includes a wireless network identifier, and the contextual information is obtained from a wireless network detector.

Example 43 includes the non-transitory computer to readable medium of Example 41, where: the contextual information includes position data associated with the device, indicates an environment associated with the input media data, indicates an object included in the input media data, or a combination thereof, and the contextual information is obtained from a positioning system, map data, an object detector configured to detect a conditional object included in the input media data, or a combination thereof.

Example 44 includes the non-transitory computer readable medium of any of Examples 41 to 43, where the encryption condition indicates to encrypt the object class based on a physical space associated with an office, availability of a particular wireless network, a location being associated with a restricted area, or an environment being an outdoor area or a public area.

Example 45 includes the non-transitory computer readable of any of Examples 41 to 44, where the encryption condition indicates to encrypt the object class based on a physical space, an environment, an object, a positioning system, or a particular geographic location.

Example 46 includes the non-transitory computer readable medium of any of Examples 41 to 45, where the encryption condition indicates to encrypt the object class based on the object class being located on a building, a document, a sign, a vehicle, or a combination thereof.

Example 47 includes the non-transitory computer readable medium of any of Examples 41 to 46, where the object class includes a document, a whiteboard, a poster, a computer screen, a display device, an address, a street name, or all content of the input media data.

Example 48 includes the non-transitory computer readable medium of any of Examples 41 to 47, where the object class includes a human face or a license plate.

Example 49 includes the non-transitory computer readable medium of any of Examples 41 to 48, where the instructions are further executable by the one or more processors to cause the one or more processors to: access the content encryption configuration; and determine whether the status of the content encryption configuration is active or inactive; and change the status of the content encryption configuration from active to inactive based on a determination that the encryption condition is unsatisfied.

Example 50 includes the non-transitory computer readable medium of any of Examples 41 to 49, where the instructions are further executable by the one or more processors to cause the one or more processors to: obtain the input media data; detect the instance of the object class within input media data; based on the encryption condition being satisfied, obtain an encryption key for the object class, where the portion of the input media data is encrypted based on the encryption key; and generate output media data that includes the encrypted media data.

Example 51 includes the non-transitory computer to readable medium of Example 50, where the instructions are further executable by the one or more processors to cause the one or more processors to: mask the portion of the input media data to generate a masked version of the input media data, and where the output media data that includes the masked version of the input media data.

Example 52 includes the non-transitory computer readable medium of Example 50 or Example 51, where the instructions are further executable by the one or more processors to cause the one or more processors to: receive, from another device, the content encryption configuration, where the status of the content encryption configuration obtained from the other device is inactive, and where the output media data includes an indicator that indicates an encryption key, a public key, the encrypted media data, the content encryption configuration, the object class, a device identifier or a user of the device, or a combination thereof.

Example 53 includes the non-transitory computer readable medium of any of Examples 50 to 52, where the instructions are further executable by the one or more processors to cause the one or more processors to output, via a display device, display data based on the output media data.

Example 54 includes the non-transitory computer readable medium of any of Examples 41 to 53, where the instructions are further executable by the one or more processors to cause the one or more processors to store the encrypted media data at a memory.

Example 55 includes the non-transitory computer readable medium of any of Examples 41 to 54, where the instructions are further executable by the one or more processors to cause the one or more processors to send the encrypted media data to a decoder device.

Example 56 includes the non-transitory computer readable medium of any of Examples 41 to 55, where the instructions are further executable by the one or more processors to cause the one or more processors to generate, via one or more cameras, the input media data.

Example 57 includes the non-transitory computer readable medium of any of Examples 41 to 56, where the instructions are further executable by the one or more processors to cause the one or more processors to transmit, via a modem, the encrypted media data to a decoder device.

Example 58 includes the non-transitory computer readable medium of any of Examples 41 to 57, where the instructions are further executable by the one or more processors to cause the one or more processors to receive, from an input device, an input that includes a request to generate the input media data.

Example 59 includes the non-transitory computer readable medium of any of Examples 41 to 58, where the one or more processors are integrated in a mobile phone, a tablet computer device, a wearable electronic device, a virtual reality headset, a mixed reality headset, an augmented reality headset, or a camera device.

Example 60 includes the non-transitory computer readable medium of any of Examples 41 to 58, where the one or more processors are integrated in a vehicle.

According to Example 61, an apparatus includes: means for obtaining a content encryption configuration indicating an object class, an encryption condition, and a status that indicates whether the content encryption configuration is active or inactive; means for obtaining contextual information associated with input media data; means for determining whether an encryption condition is satisfied based on the contextual information; means for changing, based on a determination that the encryption condition is satisfied, the status of the content encryption configuration to active; and means for encrypting, based on the encryption condition being satisfied, a portion of the input media data that includes an instance of an object class to generate encrypted media data.

Example 62 includes the apparatus of Example 61, where: the contextual information includes a wireless network identifier, and the contextual information is obtained from a wireless network detector.

Example 63 includes the apparatus of Example 61, where: the contextual information includes position data associated with the device, indicates an environment associated with the input media data, indicates an object included in the input media data, or a combination thereof, and the contextual information is obtained from a positioning system, map data, an object detector configured to detect a conditional object included in the input media data, or a combination thereof.

Example 64 includes the apparatus of any of Examples 61 to 63, where the encryption condition indicates to encrypt the object class based on a physical space associated with an office, availability of a particular wireless network, a location being associated with a restricted area, or an environment being an outdoor area or a public area.

Example 65 includes the apparatus of any of Examples 61 to 64, where the encryption condition indicates to encrypt the object class based on a physical space, an environment, an object, a positioning system, or a particular geographic location.

Example 66 includes the apparatus of any of Examples 61 to 65, where the encryption condition indicates to encrypt the object class based on the object class being located on a building, a document, a sign, a vehicle, or a combination thereof.

Example 67 includes the apparatus of any of Examples 61 to 66, where the object class includes a document, a whiteboard, a poster, a computer screen, a display device, an address, a street name, or all content of the input media data.

Example 68 includes the apparatus of any of Examples 61 to 67, where the object class includes a human face or a license plate.

Example 69 includes the apparatus of any of Examples 61 to 68, and further includes: means for accessing the content encryption configuration; and means for determining whether the status of the content encryption configuration is active or inactive; and means for changing the status of the content encryption configuration from active to inactive based on a determination that the encryption condition is unsatisfied.

Example 70 includes the apparatus of any of Examples 61 to 69, and further includes: means for obtaining the input media data; means for detecting the instance of the object class within input media data; means for obtaining, based on the encryption condition being satisfied, an encryption key for the object class, where the portion of the input media data is encrypted based on the encryption key; and means for generating output media data that includes the encrypted media data.

Example 71 includes the apparatus of Example 70, and further includes: means for masking the portion of the input media data to generate a masked version of the input media data, and where the output media data that includes the masked version of the input media data.

Example 72 includes the apparatus of Example 70 or Example 71, and further includes: means for receiving, from another device, the content encryption configuration, where the status of the content encryption configuration obtained from the other device is inactive, and where the output media data includes an indicator that indicates an encryption key, a public key, the encrypted media data, the content encryption configuration, the object class, a device identifier or a user of the device, or a combination thereof.

Example 73 includes the apparatus of any of Examples 70 to 72, and further includes means for outputting display data based on the output media data.

Example 74 includes the apparatus of any of Examples 61 to 73, and further includes means for storing the encrypted media data at a memory.

Example 75 includes the apparatus of any of Examples 61 to 74, and further includes means for sending the encrypted media data to a decoder device.

Example 76 includes the apparatus of any of Examples 61 to 75, and further includes means for generating the input media data.

Example 77 includes the apparatus of any of Examples 61 to 76, and further includes means for transmitting the encrypted media data to a decoder device.

Example 78 includes the apparatus of any of Examples 61 to 77, and further includes means for receiving an input that includes a request to generate the input media data.

Example 79 includes the apparatus of any of Examples 61 to 78, where the apparatus is integrated a mobile phone, a tablet computer device, a wearable electronic device, a virtual reality headset, a mixed reality headset, an augmented reality headset, or a camera device.

Example 80 includes the apparatus of any of Examples 61 to 78, where the apparatus is integrated in a vehicle.

Example 81 includes the device of any of Examples 1 to 18, where the content encryption configuration includes a plurality of entries, each entry indicating a respective object class, a respective encryption condition, and a respective status, and where the one or more processors are configured to independently determine, for each entry, whether the respective encryption condition is satisfied and to independently change the respective status based on the determination.

Example 82 includes the device of any of Examples 1 to 18, where the one or more processors are configured to, based on the status of the content encryption configuration being active, monitor for a monitoring period without re-evaluating the encryption condition, where the monitoring period is based on a time duration, a number of frames of the input media data, or a combination thereof, and where the one or more processors are configured to, after the monitoring period, determine whether to maintain the status as active based on detection of the instance of the object class in the input media data during the monitoring period.

Example 83 includes the device of Example 82, where the one or more processors are configured to extend the monitoring period based on a determination that the instance of the object class is detected in the input media data during the monitoring period, and to re-evaluate the encryption condition based on a determination that the instance of the object class is not detected in the input media data during the monitoring period.

Example 84 includes the device of any of Examples 1 to 18, where the one or more processors are configured to: detect, in the input media data, the instance of the object class and identify a region of interest corresponding to the instance; encrypt region of interest content corresponding to the region of interest to generate encrypted region of interest data; mask the region of interest to generate a masked version of the input media data; and generate output media data comprising a bitstream that includes an encoded masked image frame corresponding to the masked version of the input media data and an encoded encrypted region of interest frame corresponding to the encrypted region of interest data.

Example 85 includes the device of any of Examples 1 to 18, where the one or more processors are configured to generate output media data such that a decoder device that does not possess a decryption key corresponding to the encrypted media data outputs a masked version of the input media data, and a decoder device that possesses the decryption key decrypts the encrypted media data and combines decrypted content with the masked version of the input media data to reconstruct at least a portion of the input media data.

According to Example 86, a device includes: a memory configured to store a content encryption configuration that indicates an object class and an encryption condition; and one or more processors configured to: obtain contextual information associated with input media data; determine whether the encryption condition is satisfied based on the contextual information; detect, in the input media data, an instance of the object class and identify a region of interest corresponding to the instance; based on a determination that the encryption condition is satisfied, encrypt region of interest content corresponding to the region of interest to generate encrypted region of interest data, and mask the region of interest to generate a masked version of the input media data; and generate output media data comprising a bitstream that includes an encoded masked image frame corresponding to the masked version of the input media data and an encoded encrypted region of interest frame corresponding to the encrypted region of interest data, where the encoded encrypted region of interest frame is indicated as a non-display frame by a non-display indicator, and where a frame identifier associates the encoded encrypted region of interest frame with the encoded masked image frame.

Example 87 includes the device of Example 86, where the encoded encrypted region of interest frame is encoded as a no-display supplemental enhancement information (SEI) message.

Example 88 includes the device of any of Examples 86 to 87, where the output media data further includes at least one of: position data indicating a position within the encoded masked image frame at which decrypted content is to be inserted, or an encoded segmentation frame including segmentation data indicating the region of interest.

Example 89 includes the device of Example 88, where the encoded segmentation frame is indicated as a non-display frame.

Example 90 includes the device of any of Examples 86 to 89, where the output media data further includes content protection data including an encryption indicator indicating that the bitstream includes the encrypted region of interest data, a condition indicator indicating the encryption condition, and an object class indicator indicating the object class.

Example 91 includes the device of any of Examples 86 to 90, where the region of interest content is encrypted using a format-preserving encryption scheme.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store a content encryption configuration that indicates an object class, an encryption condition, and a status that indicates whether the content encryption configuration is active or inactive; and
one or more processors configured to:
obtain contextual information associated with input media data;
determine whether the encryption condition is satisfied based on the contextual information;
based on a determination that the encryption condition is satisfied, change the status of the content encryption configuration to active; and
based on the encryption condition being satisfied, encrypt a portion of the input media data that includes an instance of the object class to generate encrypted media data.

2. The device of claim 1, wherein:
the contextual information includes a wireless network identifier, and
the contextual information is obtained from a wireless network detector.

3. The device of claim 1, wherein:
the contextual information includes position data associated with the device, indicates an environment associated with the input media data, indicates an object included in the input media data, or a combination thereof, and
the contextual information is obtained from a positioning system, map data, an object detector configured to detect a conditional object included in the input media data, or a combination thereof.

4. The device of claim 1, wherein the encryption condition indicates to encrypt the object class based on a physical space associated with an office, availability of a particular wireless network, a location being associated with a restricted area, or an environment being an outdoor area or a public area.

5. The device of claim 1, wherein the encryption condition indicates to encrypt the object class based on a physical space, an environment, an object, a positioning system, or a particular geographic location.

6. The device of claim 1, wherein the encryption condition indicates to encrypt the object class based on the object class being located on a building, a document, a sign, a vehicle, or a combination thereof.

7. The device of claim 1, wherein the object class includes a document, a whiteboard, a poster, a computer screen, a display device, an address, a street name, or all content of the input media data.

8. The device of claim 1, wherein the object class includes a human face or a license plate.

9. The device of claim 1, wherein the one or more processors are configured to:
access the content encryption configuration; and
determine whether the status of the content encryption configuration is active or inactive; and
change the status of the content encryption configuration from active to inactive based on a determination that the encryption condition is unsatisfied.

10. The device of claim 1, wherein the one or more processors configured to:
obtain the input media data;
detect the instance of the object class within input media data;
based on the encryption condition being satisfied, obtain an encryption key for the object class, wherein the portion of the input media data is encrypted based on the encryption key; and
generate output media data that includes the encrypted media data.

11. The device of claim 10, further including a display device coupled to the one or more processors and configured to output display data based on the output media data.

12. The device of claim 1, wherein the one or more processors are configured to store the encrypted media data at the memory.

13. The device of claim 1, wherein the one or more processors are configured to send the encrypted media data to a decoder device.

14. The device of claim 1, further including one or more cameras coupled to the one or more processors, and wherein the one or more cameras are configured to generate the input media data.

15. The device of claim 1, further including a modem coupled to the one or more processors, the modem configured to transmit the encrypted media data to a decoder device.

16. The device of claim 1, further including an input device configured to receive an input and provide the input to the one or more processors, wherein the input includes a request to generate the input media data.

17. The device of claim 1, wherein the one or more processors are integrated in a mobile phone, a tablet computer device, a wearable electronic device, a virtual reality headset, a mixed reality headset, an augmented reality headset, or a camera device.

18. The device of claim 1, wherein the one or more processors are integrated in a vehicle.

19. The device of claim 1, wherein:
the content encryption configuration includes a plurality of entries, each entry indicating a respective object class, a respective encryption condition, and a respective status, and
the one or more processors are configured to independently:
determine, for each entry, whether the respective encryption condition is satisfied; and
change the respective status based on the determination.

20. The device of claim 1, wherein the one or more processors are configured to:
based on the status of the content encryption configuration being active, monitor for a monitoring period without re-evaluating the encryption condition, wherein the monitoring period is based on a time duration, a number of frames of the input media data, or a combination thereof; and
after the monitoring period, determine whether to maintain the status as active based on detection of the instance of the object class in the input media data during the monitoring period.

21. The device of claim 20, wherein the one or more processors are configured to:
extend the monitoring period based on a determination that the instance of the object class is detected in the input media data during the monitoring period; and
re-evaluate the encryption condition based on a determination that the instance of the object class is not detected in the input media data during the monitoring period.

22. The device of claim 1, wherein the one or more processors are configured to:
detect, in the input media data, the instance of the object class and identify a region of interest corresponding to the instance;
encrypt region of interest content corresponding to the region of interest to generate encrypted region of interest data; mask the region of interest to generate a masked version of the input media data; and
generate output media data comprising a bitstream that includes an encoded masked image frame corresponding to the masked version of the input media data and an encoded encrypted region of interest frame corresponding to the encrypted region of interest data.

23. A non-transitory computer-readable medium that stores instructions that are executable by one or more processors to cause the one or more processors to:
obtain a content encryption configuration indicating an object class, an encryption condition, and a status that indicates whether the content encryption configuration is active or inactive;
obtain contextual information associated with input media data;
determine whether the encryption condition is satisfied based on the contextual information;
based on a determination that the encryption condition is satisfied, change the status of the content encryption configuration to active; and
based on the encryption condition being satisfied, encrypt a portion of the input media data that includes an instance of the object class to generate encrypted media data.

24. An apparatus comprising:
means for obtaining a content encryption configuration indicating an object class, an encryption condition, and a status that indicates whether the content encryption configuration is active or inactive;
means for obtaining contextual information associated with input media data;
means for determining whether the encryption condition is satisfied based on the contextual information;
means for changing, based on a determination that the encryption condition is satisfied, the status of the content encryption configuration to active; and
means for encrypting, based on the encryption condition being satisfied, a portion of the input media data that includes an instance of the object class to generate encrypted media data.

25. A device comprising:
a memory configured to store a content encryption configuration that indicates an object class, an encryption condition, and a status that indicates whether the content encryption configuration is active or inactive; and
one or more processors configured to:
obtain contextual information associated with input media data;
determine whether the encryption condition is satisfied based on the contextual information;
detect, in the input media data, an instance of the object class and identify a region of interest corresponding to the instance;
based on a determination that the encryption condition is satisfied, encrypt region of interest content corresponding to the region of interest to generate encrypted region of interest data, and mask the region of interest to generate a masked version of the input media data; and
generate output media data comprising a bitstream that includes an encoded masked image frame corresponding to the masked version of the input media data and an encoded encrypted region of interest frame corresponding to the encrypted region of interest data,
wherein the encoded encrypted region of interest frame is indicated as a non-display frame by a non-display indicator, and
wherein a frame identifier associates the encoded encrypted region of interest frame with the encoded masked image frame.

26. The device of claim 25, wherein the encoded encrypted region of interest frame is encoded as a no-display supplemental enhancement information (SEI) message.

27. The device of claim 25, wherein the output media data further includes at least one of: position data indicating a position within the encoded masked image frame at which decrypted content is to be inserted, or an encoded segmentation frame including segmentation data indicating the region of interest.

28. The device of claim 27, wherein the encoded segmentation frame is indicated as a non-display frame.

29. The device of claim 25, wherein the output media data further includes content protection data including an encryption indicator indicating that the bitstream includes the encrypted region of interest data, a condition indicator indicating the encryption condition, and an object class indicator indicating the object class.

30. The device of claim 25, wherein the region of interest content is encrypted using a format-preserving encryption scheme.
